(19) United States
(12) Patent Application Publication
(10) Pub. No.: US 2026/0259293 A1
(43) Pub. Date: Sep. 3, 2026

(54) RADAR-ASSISTED DISTRIBUTED SELF-POSITIONING

(71) Applicant: Telefonaktiebolaget LM Ericsson (publ), Stockholm (SE)

(72) Inventors: Fredrik Dahlgren, Lund (SE); Magnus Olsson, KLAGSHAMN (SE); Gang Zou, Lund (SE); Magnus Sandgren, STAFFANSTORP (SE); Ashkan Kalantari, MALMÖ (SE); Henrik Sjöland, Lund (SE)

(21) Appl. No.: 18/713,253

(22) PCT Filed: Nov. 30, 2021
(86) PCT No.: PCT/EP2021/083582

§ 371 Date: May 24, 2024

(51) Int. Cl. G01S 5/02; G01S 13/90

(52) U.S. Cl. CPC G01S 5/0268; G01S 5/0244; G01S 13/90

(57) ABSTRACT

A location of a first mobile communication device is determined by a server obtaining a first estimate of a position of the first mobile communication device, wherein the first estimate identifies a position within a local area portion of a reference coordinate system. One or more parameters that guide a sensing of a local area of the first mobile communication device are determined and sent to the first mobile communication device. In response, the server receives first sense data of the local area and uses the received data to determine a second estimate of the position of the first mobile communication device, wherein the second estimate is more accurate than the first estimate.

### BACKGROUND

The present invention relates to technology that enables a mobile communication device to obtain information indicative of its location and more particularly to technology that utilizes radar information to assist with determining the information indicative of a mobile communication device's location.

There is a growing need for applications in modem-equipped devices to be aware of their own geographic positions (“self-position”) with high accuracy. There are several radio-based positioning technologies related to cellular communication as well as Bluetooth-compliant technology providing the positioning accuracy of a few meters (better under certain conditions). In US Patent Publication No. US20170307746A1 (published in 2017), a vehicle compares a radar map with a reference data map to localize itself. In US Patent Publication No. US20190171224A1 (published 2019) a vehicle creates a map of its environment in a first step and then uses the environment features and stationary reflections to localize itself; non-stationary objects are identified to not cause location errors. The referenced patent document mentions that relative velocity (self-movement) can be derived based on direct measurements of the radial speeds of reflection points from stationary objects, measured relative to the observer. This also allows determination of rotation when using multiple spatial distributed radar sensors.

Deterministic and stochastic radar responses are used in Liu et al., A Radar-Based Simultaneous Localization and Mapping Paradigm for Scattering Map Modeling, IEEE Asia-Pacific Conference on Antennas and Propagation (APCAP), Auckland, New Zealand (2018), to build a map of the environment and localize the radar. US Patent Publication No. US20200233280A1 discloses a method for determining the position of a vehicle by matching radar detection points with a predefined navigation map which comprising elements representing static landmarks around the vehicle. The publication also mentions “the navigation map can be derived from a global database on the basis of a given position of the vehicle, e.g. from a global position system of the vehicle.” The approach described in Marck et al., “Indoor Radar SLAM A Radar Application For Vision And GPS Denied Environments”, European Microwave Conference, Nuremberg, Germany (2013) involves feeding the radar image into a mapping and localization algorithm and using an iterative closest point algorithm to determine the radar location and movement, whereas a particle filter optimizes measurement performance. As shown in Marck et al., radar-based Simultaneous Localization and Mapping (SLAM) generally requires 360 degrees panoramic high-resolution range information which can be achieved by either a radar apparatus with rotating antenna or an electronically scanned phased array radar.

In another disclosure, US Patent Publication No. US20200256977A1 (published 2020) describes a vehicle using at least one radar sensor to generate a map of the environment and then comparing its current measurement with the generated map to localize itself. As similarly disclosed in US Patent Publication No. US20200232801A1, a vehicle uses radar to create a local map and then retrieves a map of the environment and correlates the two to localize itself. And as described in US Patent Publication No. US20190384318A1, a device uses a radar signal to create a local grid map and compares this with a map stored in the device's memory to localize itself.

Other sensor options for localization include the use of cameras where techniques such as SLAM can support a more accurate relative position. Information from different sensors may be combined in so-called sensor fusion. Using radar-based SLAM, a device can map an unknown environment and localize itself in the environment.

There are a number of problems associated with conventional positioning technology. For example, radio-based positioning that relies exclusively on the communication between one or a few base stations or anchor points and a device produces results that are accurate only down to within a few meters unless a large number of anchor transmitters are provided, the clock synchronization is extremely accurate, or certain assumptions can be made on the environment or relative position. Such systems scale poorly with respect to accuracy (not consistent, from at best around 2 meters but sometimes several meters) and cost. Furthermore, the positions of the base stations or access points also need to be very accurately known, which adds to installation cost and can cause problems if these are moved later on.

As the deployment of indoor base stations foremost aims to cater to coverage of communication services, it is very likely that there could be significant gaps in coverage of the areas that can obtain an accurate enough position. In some cases it might even lead to zones and spots where conventional positioning technology works poorly (even though, in some cases, communication may still be possible).

An alternative approach, sensor fusion, which combines sensor data from SLAM with, for example, data derived from radio-based positioning, GPS, and/or cameras, and inertial measurement units (IMUs) for movement changes, can lead to high accuracy, but demands multiple sensors which adds significant complexity, cost, printed circuit board (PCB) area, and device size.

PCT Publication No. WO2017139432 (published 9 Feb. 2017) presents a solution for fingerprinting local depth-based sensor data with map-data of geometric structures. The fingerprinting is based on geometric analysis. Radar is mentioned as one many different types of potential sensors that may be used to generate depth-wise information. However, the fingerprinting is not based on radar-signals.

Patent Publication No. US20190171224A1 (published 6 Jun. 2019) presents a radar-based technique for fine-tuning self-position based on first creating a map of the environment and thereafter fine-tuning self-position by correlating to that map. Both the map and the fine-tuning are performed by the device. The target area is vehicles with an aim to, for example, enable autonomous parking.

Liu, X. et al., “A Radar-Based Simultaneous Localization and Mapping Paradigm for Scattering Map Modeling”, IEEE Asia-Pacific Conference on Antennas and Propagation (APCAP), Auckland, New Zealand (2018); and Marck et al., “Indoor radar SLAM A radar application for vision and GPS denied environments”, European Microwave Conference, Nuremberg, Germany (2013) describe research studies showing the possible use of radar SLAM for positioning. However, such use demands very intense radar usage and is consequently an extravagant expenditure of energy and processing resources if it is being used only for performing self-positioning at quick occasions with relatively low amounts of modem activity. There is therefore a need for self-positioning technology that addresses the above and/or related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) that determines a location of a first mobile communication device. Location determination comprises obtaining a first estimate of a position of the first mobile communication device, wherein the first estimate identifies a position within a local area portion of a reference coordinate system. One or more parameters that guide a sensing of a local area of the first mobile communication device are determined, and sent to the first mobile communication device. First sense data of the local area is received in response to the sending.

The first sense data of the local area is used to determine a second estimate of the position of the first mobile communication device, wherein the second estimate is more accurate than the first estimate.

In an aspect of some but not necessarily all embodiments consistent with the invention, location determination comprises obtaining a measure of accuracy of the first estimate of the position of the first mobile communication device; and determining whether the measure of accuracy of the first estimate of the position of the first mobile communication device satisfies a predefined threshold level of accuracy, wherein sending the one or more parameters is performed when the measure of accuracy of the first estimate of the position of the first mobile communication device does not satisfy the predefined threshold level of accuracy. In some but not necessarily all such embodiments, the measure of accuracy of the first estimate of the position of the first mobile communication device is obtained from the first mobile communication device.

In another aspect of some but not necessarily all embodiments consistent with the invention, location determination comprises detecting that the first mobile communication device is located in a local area for which historical sense data that is available to the server does not satisfy at least one predetermined criterion, wherein sending the one or more parameters is performed in response to said detecting.

In yet another aspect of some but not necessarily all embodiments consistent with the invention, the sensing of the local area is radar sensing of the local area; and the one or more parameters define a pose that the first mobile communications device is to assume when performing the radar sensing of the local area.

In still another aspect of some but not necessarily all embodiments consistent with the invention, the sensing of the local area is radar sensing of the local area; and the one or more parameters define movement to a location at which the radar sensing of the local area is to be performed.

In yet another aspect of some but not necessarily all embodiments consistent with the invention, the sensing of the local area is millimeter-wave Synthetic Aperture Radar (mmWave SAR) sensing. In some but not necessarily all such embodiments, the one or more parameters define a direction and/or an orientation to be applied when performing the mm Wave SAR sensing. In some other but not necessarily all such embodiments, using the first sense data of the local area to determine the second estimate of the position of the first mobile communication device comprises correlating the first sense data of the local area with a reference map that includes information about one or more physical features located behind one or more materials from a viewpoint of the first mobile communication device.

In still another aspect of some but not necessarily all embodiments consistent with the invention, the sensing of the first area is non-radar based sensing.

In another aspect of some but not necessarily all embodiments consistent with the invention, the sensing of the local area is radar sensing of the local area; and the one or more parameters define one or more of:
a higher power setting of radar signaling than was used in a previous sensing by the first mobile communication device;
a larger bandwidth setting of radar signaling than was used in a previous sensing by the first mobile communication device;
a longer signal duration of radar signaling than was used in a previous sensing by the first mobile communication device; and
an additional frequency to be used for radar signaling than was used in a previous sensing by the first mobile communication device.

In yet another aspect of some but not necessarily all embodiments consistent with the invention, location determination comprises sending the second estimate of the position of the first mobile communication device to the first mobile communication device.

In still another aspect of some but not necessarily all embodiments consistent with the invention, location determination comprises using the first sense data of the local area as a basis for revising a reference map of the local area.

In another aspect of some but not necessarily all embodiments consistent with the invention, location determination comprises initially using non-radar based information to obtain the first estimate of the position of the first mobile communication device.

In yet another aspect of some but not necessarily all embodiments consistent with the invention, the first estimate of the position of the first mobile communication device is obtained from the first mobile communication device.

In still another aspect of some but not necessarily all embodiments consistent with the invention, location determination comprises causing the second estimate of the position of the first mobile communication device to be used as a basis for adjusting a telecommunications function of a telecommunications network node of a telecommunications network, wherein the telecommunications function pertains to the first mobile communications device operating in the telecommunications network.

In another aspect of some but not necessarily all embodiments consistent with the invention, location determination comprises sending to a second mobile communication device one or more second parameters that guide a sensing of the local area by the second mobile communication device; and receiving second sense data from the second mobile communication device, wherein using the first sense data of the local area to determine the second estimate of the position of the first mobile communication device comprises using the first sense data and the second sense data to determine the second estimate of the position of the first mobile communication device.

In still another aspect of some but not necessarily all embodiments consistent with the invention, using the first sense data of the local area to determine the second estimate of the position of the first mobile communication device is based on a correlation between the first sense data and a reference map, and using the first sense data of the local area to determine the second estimate of the position of the first mobile communication device comprises detecting a pattern of changes with respect to an object or feature represented in the reference map and using knowledge about the detected pattern when correlating the first sense data with the reference map.

In another aspect of some but not necessarily all embodiments consistent with the invention, using the first sense data of the local area to determine the second estimate of the position of the first mobile communication device is based on correlation results produced by correlating the first sense data with a reference map, and location determination comprises obtaining information about a position and/or movement of a second mobile device; and filtering the correlation results to account for the position and/or movement of the second mobile device.

### BRIEF DESCRIPTION OF THE DRAWINGS

The objects and advantages of the invention will be understood by reading the following detailed description in conjunction with the drawings in which:

FIG. 1 is a block diagram of an exemplary system that is consistent with inventive embodiments.

FIG. 2 illustrates an exemplary WR-Frame.

FIG. 3A is a signaling diagram illustrating aspects of one class of embodiments consistent with the invention.

FIG. 3B is a signaling diagram illustrating aspects of an alternative class of embodiments consistent with the invention.

FIG. 4 shows example when the mobile device (UE) is in a surrounding area.

FIG. 5 is a signaling diagram illustrating aspects of an alternative class of embodiments consistent with the invention.

FIG. 6 is, in one respect, a flowchart of actions performed by a server in accordance with a number of embodiments consistent with the invention.

FIG. 7 is, in one respect, a flowchart of actions performed by an exemplary mobile communication device configured to perform sensing in accordance with a number of embodiments to produce data that can be analyzed to estimate the position of the mobile communication device.

FIG. 8 is a signaling diagram illustrating aspects of an alternative class of embodiments consistent with the invention.

FIG. 9 shows details of a network node according to one or more embodiments.

FIG. 10 shows details of a wireless device according to one or more embodiments.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

The herein-described technology addresses the need for a device to be able to obtain an accurate positioning of itself (so called “self-position”) in an area in which today's typical technology (e.g., GPS), does not perform well enough (e.g., in urban canyons, indoors, factory floor etc.). Furthermore, the goal is to do so without the need for sensing capability other than radar (which can be provided by a modem with radar capabilities, or by a separate radar module incorporated into the device) in some but not necessarily all embodiments, an accelerometer or compass can additionally be used. But in all such embodiments, the technology does not require any need for a camera or for an ambitious network of base stations or other high-cost network-based positioning equipment.

The various embodiments described herein are capable of deriving self positioning information with cm-range accuracy when relatively close to objects and structures (a few meters away), and slightly lower accuracy when objects are far away.

In an aspect of embodiments described herein a world reference (WR) map is obtained based at least on other radio-based position solutions that can achieve an accuracy of 5-10 meters (potentially better, but also potentially worse). With the WR map as a starting point, information obtained by means of radar scanning is used to finetune the self-position of the device within the WR frame. In the following, the term “WRP” is used to refer to the estimated world reference position according to a standardized radio-based method such as, but not limited to, Observed Time Difference Of Arrival (“OTDOA”) (other approaches can be used to determine the WRP see examples below). The term “WR-Frame” is herein used to refer to the local area around the WRP as defined by the estimated accuracy of WRP. For example, if the accuracy of the WRP is estimated to be ±5 meters, then the WR-Frame is the area defined by WRP±5 meters in each direction. More generally, the WR-Frame is an exemplary embodiment of a local area portion of a reference coordinate system (which, in this embodiment, is the world reference map).

Finetuning the self-position within the WR-Frame is done by capturing radar responses according to suitable settings, uploading the captured radar responses to a mobile edge server function (MEF), and applying correlation methods (e.g., fingerprinting or correlation relative to map information, or a combination) where the provided radar data is correlated with previous information of the environment. Since the MEF knows that the device is within the WR-Frame area, it needs only to correlate relative to that. This can achieve positioning accuracy of the wanted levels.

An important aspect of embodiments consistent with the invention is the offloading of processing within the MEF and also the data that is made available in the MEF, enabling a large set of different optimizations and refinements. Furthermore, by this approach, the MEF will have very accurate information of the position of all devices, with an estimate of their trajectories, that can be useful for many different tasks and optimizations and included in correlations providing further information about environment dynamics due to moving objects.

There are a number of different embodiments that apply the above-described aspects, and these are discussed further in the following.

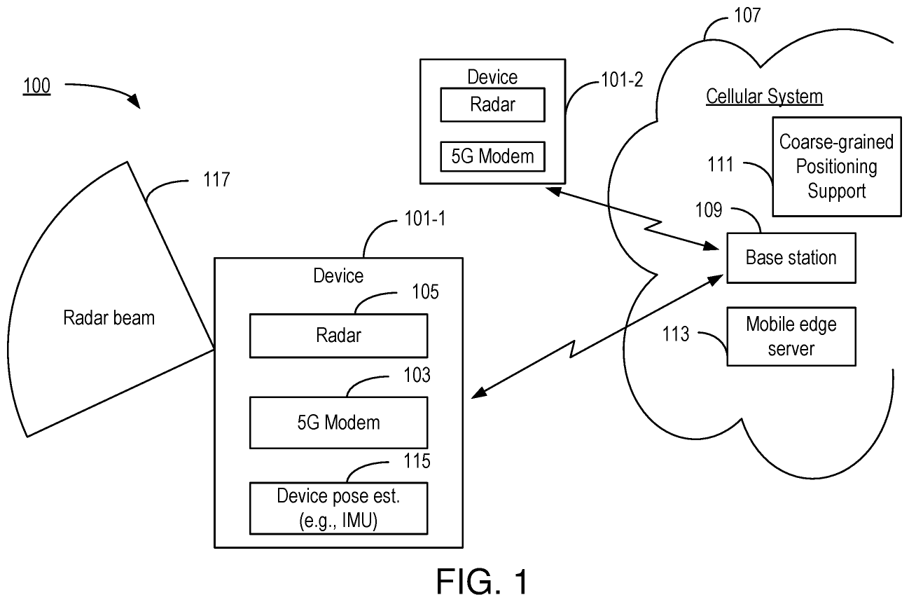

FIG. 1 is a block diagram of an exemplary system 100 that is consistent with inventive embodiments. The exemplary system 100 comprises:
Mobile communication devices (or User Equipment-UE) 101-1, 101-2, each comprising a modem 103 and configured with Radar functionality 105 (implemented either by using the modem 103 or with separate radar circuitry as shown in FIG. 1). There may be more or fewer of such devices in any particular embodiment.
A cellular communication system 107 comprising a base station 109 that the devices 101-1, 101-2 communicate with. The system 100 also includes or has access to positioning support 111 according to some conventional technology (e.g., GPS, OTDOA, etc.). This positioning support 111 provides coarse-grained position information to achieve a WRP and a WR-Frame.
A mobile edge server 113, which is a server residing preferably at the base station 109 for providing services that are local to the area served by the base station 109 and with lower latencies than going over-the-top to a data center (not shown) farther away. The mobile edge server 113 preferably resides at the base station 109, but its location is neither a necessary nor an essential aspect of inventive embodiments.
A device pose (also known as “orientation”) estimator 115, for example using an IMU onboard the device (very accurate) or alternatively calculated based on beam alignment towards a known reference (lower accuracy) or in another alternative using a radio-based angle measurement (medium accuracy): Using beam direction from a UE antenna panel towards the base station 109 as a reference in the spatial domain. The Angle of Arrival (AoA) and Angle of Departure (AoD) can together with Round Trip Time (RTT) measurements generate the coarse position and panel pose towards the base station 109.

These elements are discussed further in the following. To ease the description, unless it is necessary to distinguish one mobile communication device from another (e.g., to distinguish a first mobile communication device 101-1 from a second mobile communication device 101-2), a mobile communication device will generically be referred to as mobile communication device 101.

### Mobile Devices/UE's 101

It is advantageous to utilize mobile communication devices 101 that are equipped with radar functionality 105. Such functionality can be implemented as, for example, a separate circuit and/or component. It is further advantageous, however, to do this by means of a modem 103 configured not only to perform communication functions, but also to generate and transmit radar beams 117 and to receive reflected radar signals. In the preferred embodiment, the UE modem 103 is extended with radar capabilities in accordance with known techniques. One such teaching is found in PCT Patent Application No. PCT/EP2020/069491. The added cost of the radar functionality on top of that of an ordinary 5G modem is then minimal due to the ability to share antenna panels occupying a valuable space in a device. This means that the modem 103 can be used for three essential functions of the positioning system:
Communicating with the base station 109 and the functions in the mobile edge server 113
Using network-based positioning 111 for the coarse-grained WRP or WR-Frame (see above)
Improving quality/accuracy of the positioning because the radar sensing can be carried out at different frequencies, different beam directions, and with different signaling types and durations with no or minimal impact on any current 5G communication In some but not necessarily all alternative embodiments, the radar functionality 105 is implemented as a separate module that needs to be carefully setup to coexist (without causing significant interference) with a 5G modem in order to perform the joint operation as described herein. This adds cost and complexity.

In still further alternatives, it is noted that despite references to 5G-compliant modems herein, those of ordinary skill in the art will readily understand that a modem that is compliant with other communication standards or generations of 3GPP standard can instead be used.

A UE 101 having the above-mentioned capabilities would typically be used in autonomous vehicles or other mobile units having a need for high precision localization, such as autonomous vehicles deployed in an indoor environment (e.g., autonomous transport carts in fully autonomous factories, surveillance drones in factories or dense urban areas, or autonomous transport vehicles in harbors where GPS position can be quite poor due to non-line-of-site conditions (partly indoor, building walls, high piles of containers, etc.)).

For autonomous vehicles, the need for positioning (e.g., the frequency and purpose of use) can be known by the mobile device and its positioning functionality consequently can be based on the context. For example, a mobile unit that is standing still would also be able to stop or reduce the positioning attempts thus saving power and freeing up valuable resources. A mobile unit that is close to structures, such as big machinery on a factory floor, may need a more accurate position with a rate that depends on how fast it is moving. A mobile device that is far away from any structure might have lower demands on positioning accuracy since it is not at an imminent risk of colliding with anything soon. Thus, a highly-accurate position will not be necessary for it to move into the intended coordinates (assuming the accuracy of the positioning can be increased as it comes closer to its target position).

The mobile devices 101 might be equipped with an IMU or accelerometer, gyroscopic sensor, or compass for estimation 115 of orientation of the device, and the estimate the direction of the radar beams. However, alternative embodiments lacking such support are also described below.

### Cellular System and Base Station 109 Support

There are many known methods for network-based positioning that are able to provide a coarse grained position of a mobile communications device 101. Such methods include, for example, the use of Observed Time Difference Of Arrival (OTDOA), uplink Timing of Arrival (ToA), Enhanced Cell ID (E-CID), Round Trip Time (RTT) measurements, Angle of Arrival (AoA) and Angle of Departure (AoD). Radio-based position solutions can achieve an accuracy of 5-10 meter (potentially better, but not guaranteed). The idea that is employed in embodiments consistent with the invention is to use a coarse estimate of position as a world reference position (WRP), and then use further sensing (e.g., radar sensing) to finetune the position within a WR Frame centered around the WRP.

In the following, the term WRP is used to refer to the estimated world reference position according to a standardized radio-based method such as OTDOA. Other coarse positioning approaches can be used as alternatives, (see examples below). The term WR-Frame is used herein to refer to the area around the WRP as defined by the estimated accuracy of the WRP (the estimate of accuracy can be based on the method used, deployment characteristics and estimates of key components building up the uncertainty like, for example, synchronicity errors). For example, if the accuracy of WRP is estimated to be ±5 meter, then the WR-Frame is the area defined by a region centered at the WRP and extending therefrom ±5 meters in each direction.

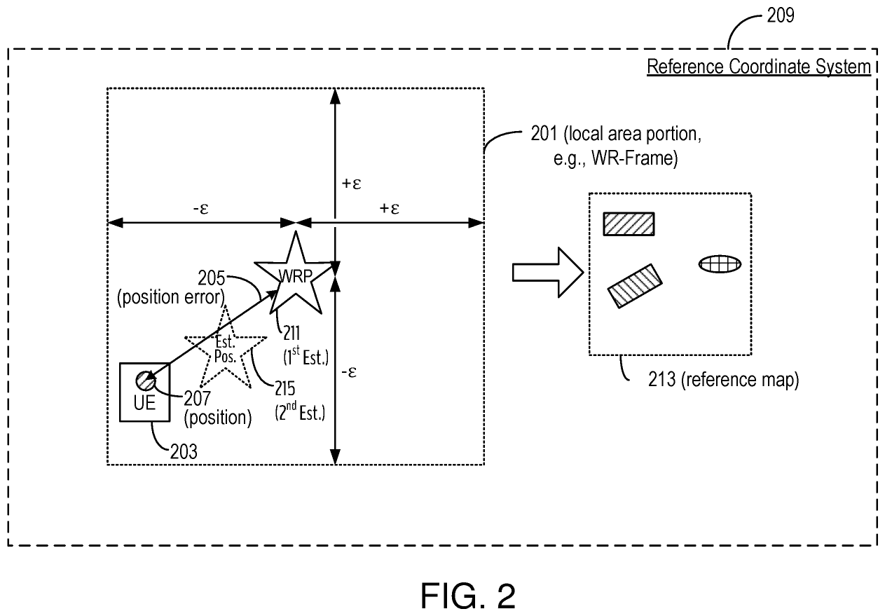

To further illustrate this point, FIG. 2 illustrates an exemplary WR-Frame 201, which is a local area portion of a (larger) reference coordinate system 209. The reference coordinate system 209 is, in general, much larger (e.g., by orders of magnitude) than the local area portion 201, and for this reason it should be understood that aspects depicted in FIG. 2 are not drawn to scale.

A UE 203 is situated at a position 207 as shown in the figure. A coarse estimate of its position (WRP) 211, is also shown having an actual error 205 as illustrated. However, when the coarse estimate, WRP, is estimated, all that is known is that its degree of accuracy is some amount ±ε. For this reason, the WR-Frame 201 is centered around the coarse estimate WRP 211. (Note: The WR-Frame 201 could alternatively be another shape, such as circular. Its particular shape is not an essential aspect of inventive embodiments.)

### Mobile Edge Server Function (MEF)

The mobile edge server 113, located within the cellular system at, for example, the base station 109, is an important element in some inventive embodiments. In one aspect, the mobile edge server 113 has access to a reference map 213 that represents objects and features that sensing would be expected to detect within different local area portions 201 of a reference coordinate system 209. It has the ability to manage the processing of supplied sensor information (e.g., radar signal information supplied by a mobile communication device 101) and correlate with previous data, map information, and other knowledge of the environment in order to improve on a coarse estimate 211 of the mobile communication device's position 207. The coarse estimate 211 of the position is, in some but not necessarily all embodiments, provided to the mobile communication device 101. And in an aspect of embodiments consistent with the invention, the mobile edge server 113 produces guidance for further sensing of the mobile communication device's vicinity in order to produce relevant sensing information that can be used to refine the first estimate of position (i.e., the coarse position) 211 into a second, more accurate one 215. The guidance for further sensing can be supplied to the mobile communication device 101 via the base station 109. Furthermore, as it is in communication with all UEs and knows their position, further optimization can be applied on a system-wide scale. These aspects are described further below.

In the exemplary embodiment illustrated in FIG. 1, the mobile edge server 113 is a standalone entity. However, in alternative embodiments the mobile edge server 113 can be implemented as extensions to the functionalities in the base station 109 or can even be handled on an internet-connected server beyond that of the base station 109. All such alternatives are contemplated to be within the scope of inventive embodiments. It is noted, however, that it is advantageous for mobile edge server functionality to be co-located with the base station 109 given the local relevance of this function and the short latencies in the communication with the UEs. With a limited geographical area the database with map information and historical data, as well as optimization based on knowledge of all UEs in the area, can be efficiently implemented. Furthermore, with the co-located system there are also significantly fewer performance reducing latencies compared to a remote over-the-top datacenter.

Later in this description, it is also pointed out that, in some alternative embodiments consistent with the invention, some of the mobile edge functionality can be handled in the mobile devices themselves. However, such embodiments may be less efficient than others.

Although in typical implementations a mobile edge function can be presumed to serve one base station, there are no principal obstacles preventing a mobile edge function from serving many base stations. Even though the maps and correlation as well as statistics are related to a local area, there might be several antenna sites served by one base station 109 and one mobile edge server 113. In the following, the system, the solution, and the examples assume one mobile edge server 113 for this functionality, but the scope of the invention is not limited to having only one such mobile edge server 113 for this.

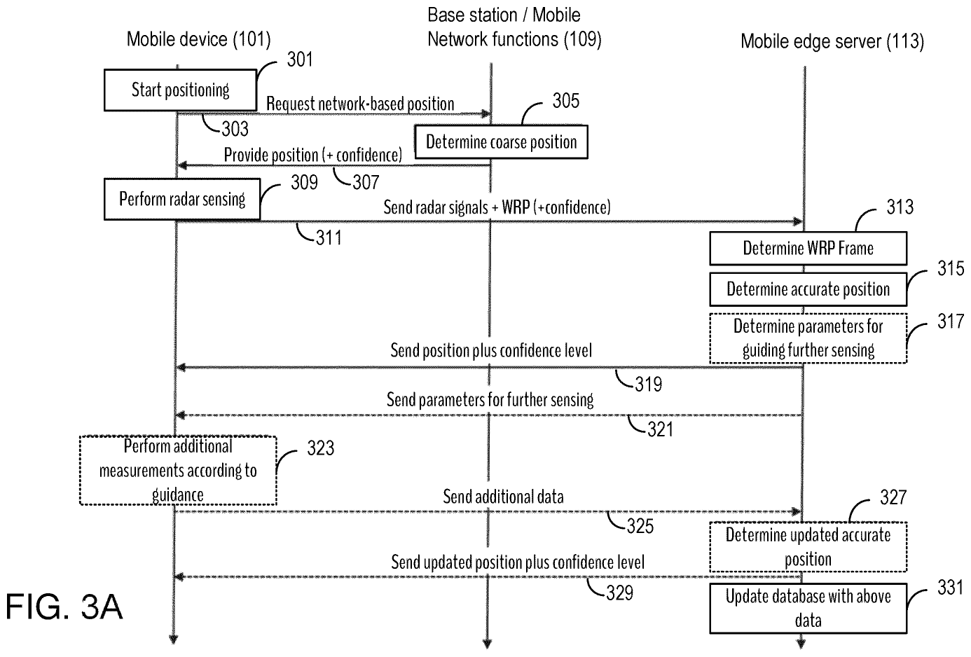

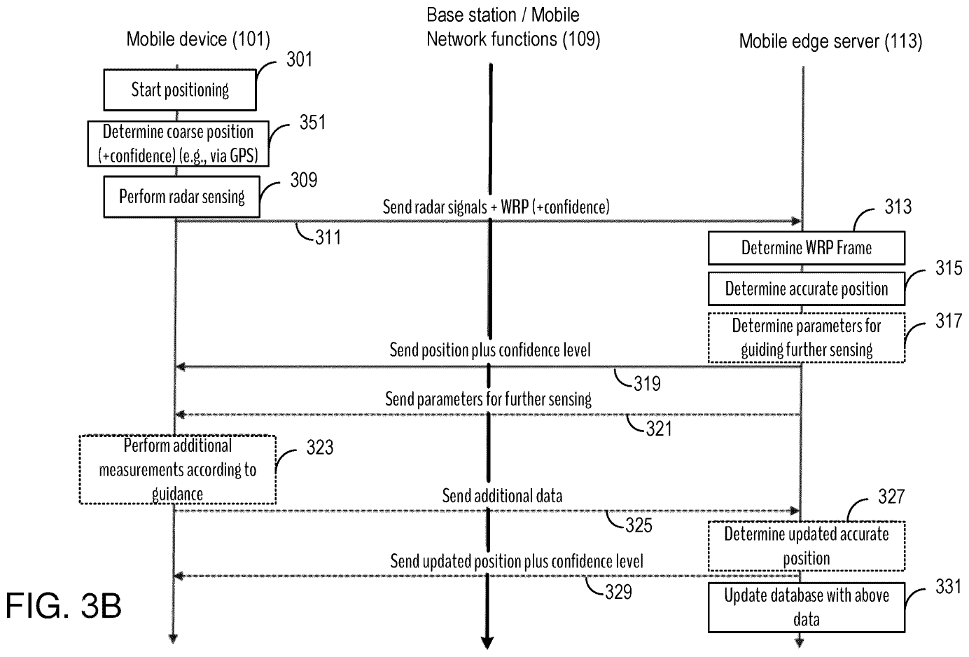

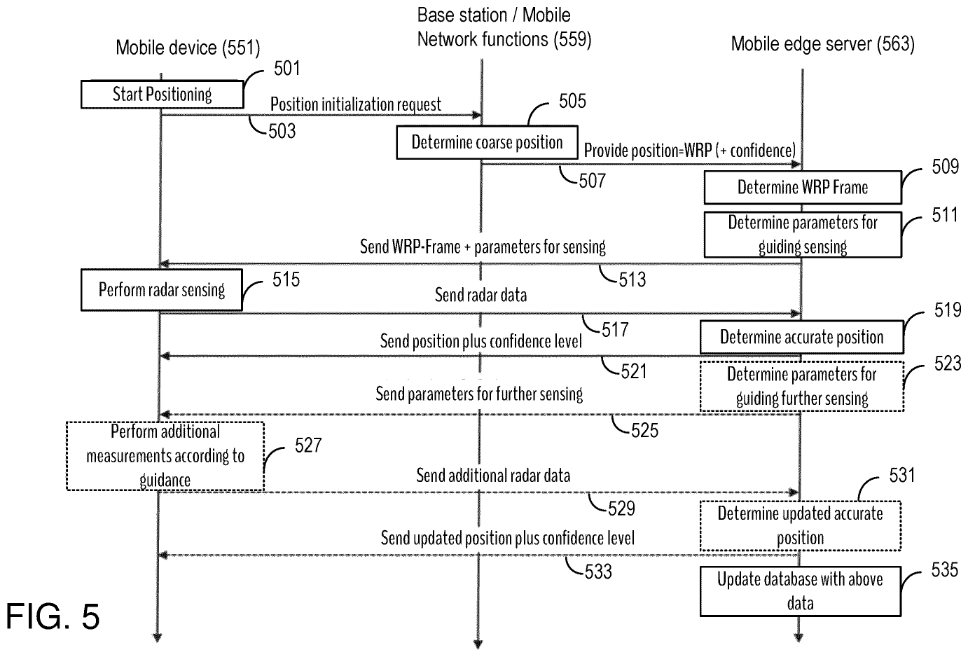

To illustrate some aspects of inventive embodiments, the description will now make reference to the exemplary signaling diagram illustrated in FIG. 3A. Features depicted with dotted lines and boxes represent aspects that are optional to this exemplary embodiment.
1. Device 101: Self-positioning is started (step 301) and as a consequence, a request for a network-based position is communicated to the base station 109 (step 303). The network executes a positioning technique that produces a coarse-grained position of the mobile device 101 (step 305). Coarse-grained positioning techniques are known in the art and all are contemplated to be within the scope of inventive embodiments.
2. The base station 109 or network function then communicates the coarse position 211 to the device (step 307). This action is included in this embodiment to illustrate environments in which there is no direct communication of this information from the base station 109 to the mobile edge server 113, so it is provided by the base station 109 to the mobile 101 which in turn forwards it to the mobile edge server 113. But in alternative embodiments, such as is shown in FIG. 5 which is discussed below, the WRP is passed directly from the base station 559 to the mobile edge server 563, so there is no need for the mobile device 551 to receive it and then forward it.
3. Device 101: Receives the coarse position 211 from the network function, which now constitutes the WRP 211. Depending on the method used in the particular embodiment, the device 101 might also receive an indication of the confidence level (e.g., an indication of degree of accuracy) of that position from the network function 109.
4. Device 101: Emit radar sequences and receive the response (step 309). The settings for the radar are based on the device knowledge of features indicated on the map or based on previously received guidance from the mobile edge server 113. For example, the network can look at the database and determine which directions have reliable amounts of available data that can be correlated with sensing data from the device and ask the device 101 to use specific panels in those directions. If there is no previous knowledge, the radar parameters are based on default parameters. This is further described below.
5. Device 101 sends received radar data to mobile edge server 113 (step 311), with the data including parameter settings used in this sensing as well as WRP 211.
6. Mobile edge server 113 (or comparable mobile edge functionality implemented in a network node such as the base station 109) determines the WR-Frame 201 (step 313) based on the WRP 211, potentially received confidence level of that WRP estimate, and historical information about WRP accuracy level of that position in that area (based on its database on prior estimates relative to determined accurate positions for all devices in that area historically). The area can be the whole network cell, or more narrowly defined based on the WRP. This function is further described below.
7. Mobile edge server 113 determines a second, more accurate estimate 215 of position 207 (step 315) based on the WR-Frame 201 and received radar data. This function is further described below.
8(alt1). Mobile edge server 113 sends the second (more accurate) estimate 215 of position to the device (step 319).
9(alt1). Mobile edge server 113 updates its database with the relevant data from the device as well as the determined accurate position (step 331). This function is further described below.

In certain cases, the mobile edge functionality (i.e., implemented as a separate mobile edge server 113 or as an auxiliary function of a network node such as a base station 109) might be able to determine the accurate position of the device with high confidence/accuracy. Reasons might be that the environment has changed, so there is no good correspondence in the in the database (e.g., map, previous radar signals, etc.), or that the WRP for certain reasons especially wrong in a specific case. One of the key advantages with the technological approach described herein is that the mobile edge function has a good overview of the map and potential reasons for the poor confidence of the estimated position, and can accordingly provide guidance the mobile device 101 to perform additional measurements that are configured to improve the accuracy of the estimated position. Such guidance can be, for example:
Move (a certain estimated distance in a known direction where according to the radar measurement there is no object in the way) and from there perform a new measurement, and send that new sensor data together with the estimated delta movement to the mobile edge function 113.
Perform an additional measurement based on a different setting of the radar signaling, e.g. higher power, larger bandwidth, longer signal duration, additional frequencies; and/or based on directing one or more radar transmissions in a different direction (e.g., using a different antenna panel) than had been performed earlier (e.g., with the expectation that the directions are associated with more distinct and unique radar signatures (e.g., as determined from available map data and data from previous radar scans at the network)); etc.

Based on this, the latter part of above flow becomes (as illustrated in the dotted boxes and signals in FIG. 3A):
8(alt2). Mobile edge function 113 determines most suitable parameters for guiding performance of additional measurements needed for a more accurate position (step 317). As noted above, this can involve the network looking at the database and determining which directions have reliable amounts of available data that can be correlated with sensing data from the device and ask the device 101 to use specific panels in those directions.
9(alt2). Mobile edge function 113 sends the second estimate (accurate) 215 of position (as determined at step 315) to the device, with an indication of (lower) confidence level (step 319)
10. Mobile edge function 113 sends parameters to device 101 for guiding performance of additional measurements (step 321)
11. Device 101 performs additional measurements according to guidance (step 323)
12. Device 101 sends additionally collected data to mobile edge function 113 (step 325)
13. Mobile edge function 113 determines updated position based on the additional data (step 327)
14. Mobile edge function 113 sends updated position with updated confidence to device 101 (step 329)
15. Mobile edge function 113 updates its database with the relevant data from the device as well as the determined accurate position (step 331).

In an alternative class of embodiments, FIG. 3B is an exemplary alternative signaling diagram that is, in most respects, identical to FIG. 3A except with respect to determination of the coarse position. Instead of this being determined at the base station 109 (as illustrated in FIG. 3A), the first (coarse) estimate 211 of position 207 (and possibly also an estimate of confidence in the first position) is determined by the mobile device 101 itself. This determination can be performed by a number of different ways including, but not limited to, use of a Global Positioning System (GPS) circuit within the mobile device 101 (step 351). In all other respects, the actions depicted in FIG. 3B are the same as the corresponding actions depicted in FIG. 3A, and for this reason reference is made to the description of FIG. 3A for a description of these depicted actions in FIG. 3B.

Further description of some of the above-mentioned steps is provided later in this document.

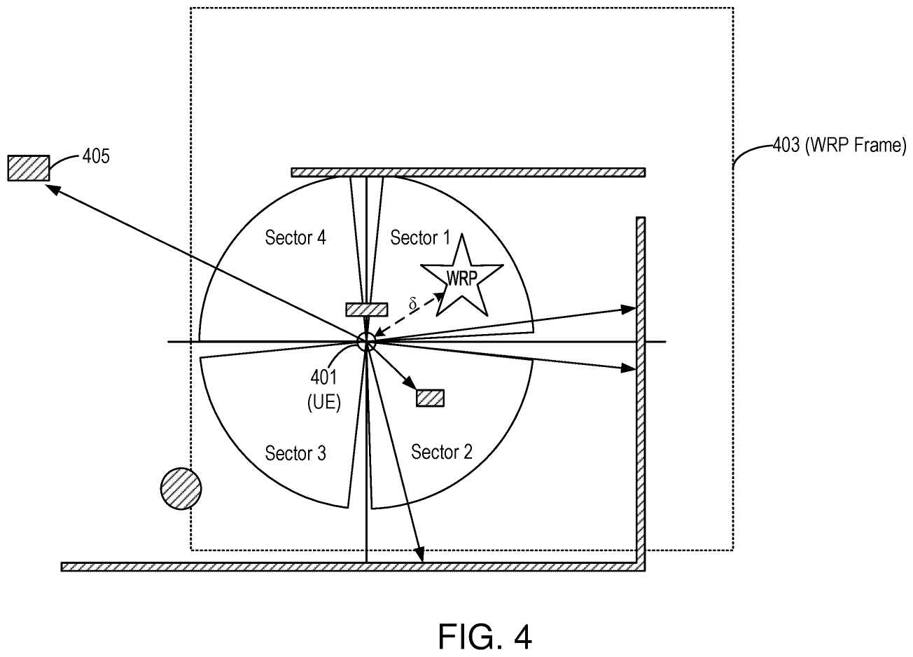

For further illustration, FIG. 4 shows an example when the mobile device (UE) 401 is in a surrounding area. In accordance with aspects of the steps illustrated in FIG. 3, the mobile edge function 113 has estimated the device's position 207 as WRP 211 having a corresponding WR-Frame 403. It can be seen that the device's estimated position, WRP, is inaccurate by an amount δ. The illustrated shapes filled with crosshatching represent nearby structures/objects (e.g., walls, machines, furniture).

In the basic operation of the examples shown in FIG. 3A, the UE 401 receives the WRP (i.e., it is estimated position), and performs the radar operation in accordance with the received guidance. In this exemplary case, radar signals are emitted in four beam directions, and for each beam direction, the UE 401 receives the reflections and estimates or calculates the radar response signal characteristics (e.g., latency, strength, Doppler characteristics, shape, etc.). The WRP and the received radar data (e.g., raw reflected radar signals or a processed version of them with extracted useful information) are sent to the mobile edge function 113. (The UE 401 sending the WRP to the mobile edge function 113 is included here to illustrate embodiments in which there is no direct communication of this information from the base station 109 to the mobile edge server 113. But in alternative embodiments, such as is shown in FIG. 5 which is discussed below, the WRP is passed directly from the base station 559 to the mobile edge server 563, so there is no need for the mobile device 551 to do this.) The mobile edge function determines the WR-Frame 403, and correlates the data derived from the radar signals with one or more reference maps 213 and/or previously recorded radar signals generated at known positions and maintained to estimate possible positions within the WR-Frame 403. Based on its holistic knowledge of the map 213 (known objects and their respective positions) that corresponds to the WR-Frame 403, as well as recorded radar signal characteristics from different positions within the WR-Frame 403, a more accurate estimate of the UE's position 207 is determined. In fact, given the different distances and signal characteristics from the different objects and structures, it can be determined that only a specific point in the WR-Frame 403 can be possible.

In certain theoretical situations, there might be multiple possible positions within a WR-Frame 403 that can lead to a same set of radar responses, but then one iteration with additional data (for example, by guiding the device 401 to move a certain distance, and perform another radar measurement which is then analyzed) would typically be sufficient to resolve the uncertainty except in very rare situations.

Since there are multiple beam directions and multiple objects being reflected, the correlation analysis is preferably configured to be able to handle certain deviations, for example when individual objects have moved but the majority of the scene is stable. In certain cases, more disruptive changes of the scene are possible (larger fraction of objects moved). Optimizations described below can help resolve such situations.

Note that even if the edge mobile function 113 correlates only for positions within the WR-Frame 403, it uses reflections from objects and structures outside the WR-Frame 403 (e.g., from the object 405). Radar beam directions, and also the WR-frame 403, need not be contained within only the X-Y dimension, but can also include upwards and downwards directions depending on system and needs.

In some embodiments, radar data from devices can include time stamps and an estimated mobility vector during the scan to take into consideration scans made from different positions. This enables further analyses and accuracy in the mobile edge function 113 since it takes into consideration multiple positions, and further consolidated knowledge on the trajectory of all devices in the area.

Some aspects mentioned above are further described in the following:

### Emitting Radar Sequences and Receiving the Responses

In simplistic implementations, the device 101 can emit radar beams in all directions according to some default radar settings and send the received signal responses to the mobile edge function 113 (jointly with WRP and radar settings). However, there are several problems with this:
The radar settings might be sub-optimal with respect to the actual context (e., g. distances to relevant objects in various directions, width of beams, certain types of objects demanding certain radar settings for optimal performance).
If radar is performed in the spectrum defined by 3GPP standards, the radar operation needs to take interference into account both with respect to interference caused to other devices by the radar signals and also interference from other devices that might disturb radar reflections. Depending on relative position of device to other devices and base stations, there might be certain directions, frequencies, and output power levels that must be avoided.
For moving devices, close proximity to other device under mobility and to certain key objects might necessitate tighter real-time operations or caution, whereas some other situations might be more relaxed in terms of real-time demands.

Embodiments consistent with the invention enable optimized operation since the mobile edge function 113 has knowledge of the overall map, as well as where all devices are positioned and their recent movements, and information on all base station positions. Optimizations enable adapting the radar to the environment, depending on expected distances and types of structures, and the radar output power, waveform, and duration might be different in different directions.

This enables the following optimizations:
A. When the mobile edge function 113 sends the accurate position to the device 101, it also sends certain key information about the area/vicinity: for example closeness/direction to other mobile devices and base stations, closeness to certain key objects or structures, and other key relevant information needed (e.g., whether there are certain rapid changes in the environment).
B. When the data in step (7) above is not sufficient for an accurate determination of the position, for example due to certain key objects having moved, the mobile edge function 113 can send further guidance to receive additional data: not only to the current device (step (10) above) but also to other nearby devices that can help collect additional updated knowledge on the environment from their respective positions. The exact protocols and rules for such procedures are beyond the scope of this description but there are several different alternative solutions that are within the ability of those of ordinary skill in the art (e.g., UEs making use of this positioning service might also be assumed to assist with additional measurements when needed if there is no issue for them doing so).
C. Further below in this document, an alternative embodiment is described that involves integrating certain optimized measurement in every radar operation.

By performing several subsequent positionings, potentially with estimates of movement in-between (if the device has the ability to estimate movement) the mobile edge function 113 can determine the position with even greater accuracy and in some but not necessarily all embodiments, apply optimizations such as reducing the size of the WR-Frame 403 for specific cases, only correlating to certain parts of the maps, and the like.

### Mobile Edge Function 113 Determining the WR-frame 403

There are multiple methods for determining the WR-Frame 403. In one of the simpler ways, a radio-based positioning scheme is used that includes indicating the degree of accuracy that can be expected (e.g., ±5 meters) and the WR-Frame 403 then becomes WRP ±5 m in each dimension. See, for example, FIG. 2. And as mentioned earlier, the WR Frame 403 can alternatively have another shape, such as but not limited to circular, ellipsoid, or spherical.

Another way of determining the WR-Frame 403 can be utilized if a position was recently determined, and if the speed (or maximum speed) of the device is known as well as direction and acceleration (or maximum acceleration). So long as the amount of time since the previous location determination is not large, a much smaller WR-Frame 403 can then be used.

However, as that confidence interval becomes pessimistic (must take the worst-case degree of accuracy for that method into consideration), an aspect of inventive embodiments provides further improvement.

More particularly, for each performed self-positioning, the mobile edge function 113 adds the related information to a stored history of WRP, the methodology employed to arrive at WRP, and the accurate position finally produced from the radar analysis. Over time, the mobile edge function 113 builds up an excellent statistical knowledge of the actual confidence interval for different WRP-methods at the different parts of the whole area-certain places might have reasonably good WRP accuracy (e.g., line of sight with base station) whereas others have very poor WRP accuracy (e.g., due to challenging radio conditions). The mobile edge function 113 further can collect statistics about WRP accuracy deviations between different modem models, and the like. Such collected information can, for example, be used as the subject of machine learning/analytics to enable accurate predictions and/or estimates and/or to identify how different factors impact accuracy. Therefore, after having performed a large number of accurate positioning services, some but not necessarily all embodiments consistent with the invention enable the mobile edge function 113 to be able to provide an optimized WR-Frame 403 taking both the environmental conditions as well as modem-type differences into consideration. This also benefits the positioning accuracy of non-radar UEs.

### Mobile Edge Function 113 Determining Accurate Position

Given the knowledge that the mobile device is within the WR-Frame 403, the task is for the mobile edge function 113 to correlate the radar signal data with data in the mobile edge server 113. This can be done according to several different approaches, such as but not limited
A. The radar data provides information for different beams on objects at certain distances. The mobile edge function 113 correlates this against map information and/or previously recorded radar signals obtained at known positions that it is maintaining, and determines the most likely position within the WR-Frame 403, with the least number of anomalies (reflections with no object correspondence in the map, or objects without any radar reflection) or any other algorithm with the best correlation (e.g., an algorithm that takes the size of anomaly or deviation into account). In this respect it is advantageous to, at certain intervals, redo or re-calibrate the algorithm based on historical data so that it can be determined, for example, whether the number of anomalies can be significantly reduced if certain structures or reflections are disregarded.

Anomalies might imply objects that have been moved, or objects with challenging reflection characteristics, which are recorded for future correlation analysis and potential update of the map information. Furthermore, the mobile edge function 113 can detect patterns changing over time, such as certain objects in the environment that are present only at certain times in which case the correlation data can include a timing variable associated with these objects.
B. The radar signals are correlated with a database of previous radar signals from different positions in the WR-Frame 403 according to a fingerprinting technology (e.g., technology that relies on known landmarks within the environment). Also for this, detected timing patterns can be determined and exploited (see above paragraph).
C. A combined approach between (A) and (B) when there are no previous radar signals from relevant positions. In such cases, methodology described in (A) is used but the radar signals are stored for future applications of the methodology described in (B).

### Mobile Edge Function 113 Updates its Database With the Relevant Data

An aspect of embodiments consistent with the invention is the ability of the mobile edge function 113 to correlate radar data against the recorded map data/database and make optimizations based on recorded data and to have a holistic view of the system status (e.g., most recent position process of UEs and their trajectories, most recent position process of relevant major objects, etc.).

The mobile edge function's database includes:
Map information, in a form that is conducive for correlating against radar reflections (at different radar parameter settings), with detailed position data of objects and structures.
Radar reflection characteristics from different directions of those objects and structures identified in the map. These can initially be calculated based on the structural map (above) given certain knowledge about material and shape. These can also be initially measured based on an enhanced device with a high-precision sensor, and only need to be done once. In an aspect of embodiments consistent with the invention, this information is continuously updated as the system is in use.
Radar signal reflections from actual devices in use, annotated with different parameter settings of the radar at the measurement.
Original WRP position and method of each positioning case, together with the accurate position derived from the radar correlation.

Furthermore, the mobile edge function 113 maintains an updated map with all connected devices using this positioning service. This enables the mobile edge function 113 to apply optimizations with respect to letting devices complement weak information of certain areas, and with respect to which beam directions might be more subject to interference from radar transmission (3GPP bands and/or others). Finally, this information also enables additional types of services based on detailed positioning and trajectory information of all devices in the area jointly with an updated view on objects and structure in that area, without demanding that the devices be equipped with cameras which would otherwise add cost and might be seen as a privacy concern. Further detail about such services is beyond the scope of this description.

### Creation of Database Data for Mobile Edge Function 113

The database of the mobile edge function 113 needs to be initially populated and then later refined iteratively through the usage-the more it is used and the more devices, the better and richer it becomes.

In one embodiment consistent with the invention, the initial content can be recorded with a certain enhanced device that has additional sensors to determine its distance moved from known accurate positions. Furthermore, a map of the environment with all static objects and structures can be created. Creation of the initial map needs to be done only once (in a factory, this might be walls, big machinery, and other notable objects), but this might exist from the start. This enhanced device records radar signals and determines how the radar echoes make certain objects visible at different distances. All this data is recorded into the database, and the map of structures and objects is updated based on its visibility and characteristics from a radar perspective.

In another embodiment consistent with the invention, an enhanced device having a camera uses some sort of Simultaneous Localization and Mapping (SLAM) (many solutions exist that are compatible with inventive embodiments) to create a map of the environment, and uses radar to annotate or update that map based on its radar reflection characteristics. This SLAM implementation need not be optimized, since this is essentially done only once. It is also possible to re-do this procedure at different intervals, but then it is not to create the initial map and radar signal content, but to update the database based on certain objects having moved or been added-in principle getting a confirmation from deviating recent radar measurements where anomalies have been identified.

### Positioning Accuracy

The positioning accuracy of the herein described technology depends on the radar signaling characteristics.

For example, a wider signal bandwidth enables more accurate measurements and resolves more details in the targets, hence providing more information for positioning. Signal to noise ratio is also of fundamental importance to radar measurement quality, and this can be improved by increased output power or by longer correlation time. The required output power and correlation time, however, grows quickly with target distance, and beyond a certain distance it becomes impractical to resolve small objects. Long correlation times also become increasingly difficult to combine with movements. To minimize the resources used and maximize the accuracy of the positioning, it is thus better to, if possible, target nearby objects with relatively low power and duration, but with high signal bandwidth. The position accuracy will be a fraction of the inverse signal bandwidth multiplied by the speed of light. If, for example, a few GHz signal bandwidth is used, the accuracy obtained by correlation of the signal modulation can be a few centimeters.

In general, more distant objects would also likely lead to somewhat less accurate measurements than would those that are close-by. This is in one respect due to longer delay before being received which gives more influence to clock jitter. It is also due to more potential unknown properties of such a long and wider signal propagation path (the beam has a finite opening angle). However, if nearby objects are missing, a reduced accuracy is tolerable for most applications, as the closer a device is to objects in its surrounding, the more accurate the positioning needs to be. Furthermore, other radio-based positioning technologies perform the worst in the close presence of significant structures and objects (more challenging radio channels, no line of sight with base stations) which is exactly the scenario for which the presently described technology can provide down to cm-accurate positioning. The nature of the methods thus make them complementary.

The listing of every possible radar characteristic that can be exploited for more in-depth assessment is beyond the scope of this description, as that also depends on the radar implementations in the devices. But overall, an important advantage of the presently described technology is that the mobile edge function 113 has a holistic understanding of the environment which enables the guidance to optimize the radar measurements depending on needs.

### Alternative Embodiment: Guided Radar Operation

To illustrate some further aspects of some but not necessarily all alternative embodiments consistent with the invention, the description will now make reference to the exemplary signaling diagram illustrated in FIG. 5. Features depicted with dotted lines and boxes represent aspects that are optional to this exemplary embodiment.
1. The mobile device 551 begins its self-positioning application (step 501) and consequently sends an self-position initialization request (step 503) to the base station 559 or other network function.
2. The base station 559 or other network function performs an initial network-based positioning function to determine WRP (potentially with some confidence level) (step 505) and provides this to the mobile edge function 563 (step 507).
3. The mobile edge function 563, in response, determines the WR-Frame that corresponds to the position WRP (step 509) and also determines parameters for guiding the radar operation based on the area, relevant objects in the surrounding, its allowed use of radar in certain frequency bands, and the like (step 511). In some but not necessarily all embodiments, the guidance can also be based on whether and what kind of radar capability the device 551 has (e.g., whether it has SAR capability). Device capability information can be supplied to the mobile edge function 563 in any number of ways including but not limited to receiving it from the device 551. By performing the sensing in accordance with the mobile edge function's guidance, the device 551 can always perform its radar operation in an optimized way that takes into account the mobile edge function's holistic knowledge of the map in that area, all other mobile devices and known dynamics in the environment, and previous historical measures from other devices in that area. The mobile edge function 563 then sends the WR-Frame and radar guidance parameters to the mobile device 551 (step 513).
4. The device 551 then emits radar sequences and receives the response (step 515). The settings for the radar are based on the device knowledge of features indicated on the map and on previously received guidance from the mobile edge server 113. This is further described below.
5. The device 551 then sends received radar data to the mobile edge server 563 (step 517) along with parameter settings used in this sensing since, in some embodiments, these may deviate from the guidance provided by the mobile edge server 563.
6. The mobile edge server 563 determines an accurate position (step 519) based on the WR-Frame and the received radar data, and sends this to the mobile device 351 (step 521).
7(alt1). The mobile edge server 363 updates its database with the relevant data from the device 351 as well as the determined accurate position (step 535).

As in an earlier described embodiment, in certain cases, the mobile edge functionality might not be able to determine the accurate position of the device with high-enough confidence/accuracy with the sensor data that it has. To address this issue, the mobile edge function, which has a good overview of the map and potential reasons for the poor confidence of estimated position, provides guidance to the mobile device 551 to perform additional measurements that are configured to improve the accuracy of the estimated position. Such guidance can be, for example:
Move (a certain estimated distance in a known direction where according to the radar measurement there is no object in the way) and from there perform a new measurement, and send that new sensor data together with the estimated delta movement to the mobile edge function 563.
Perform an additional measurement based on a different setting of the radar signaling, e.g. higher power, larger bandwidth, longer signal duration, additional frequencies, etc.

Alternatively and/or additionally, it may be that the device 551 is known, with sufficient accuracy, to be located in a local area for which historical sense data that is available to the server 113 does not satisfy at least one predetermined criterion. For example, a predetermined criterion may be a certain level of sense data associated with a particular direction at that location. By guiding the device 551 to perform sensing in that direction and to report the sense data back to the server 113, the server's database of historical sense data can be supplemented and thereby improved for future use.

Based on this, the latter part of above flow becomes (as illustrated in the dotted boxes and signals in FIG. 5):
7(alt2). The mobile edge function 563 determines parameters for performing the most suitable additional measurements needed for a more accurate position (step 523)
8. The mobile edge function 563 sends the parameters to the device 551 for guiding performance of additional measurements (step 525)
9. The device 551 performs additional measurements according to the guidance (step 527)
10. the device 551 sends additionally collected data to the mobile edge function 563 (step 529)
11. The mobile edge function 563 determines and updated position based on the additional data (step 531)
12. The mobile edge function 563 sends the updated position with updated confidence level to the device 551 (step 533)
13. The mobile edge function 563 updates its database with the relevant data from the device as well as the determined accurate position (step 535).

### Additional Alternative Embodiments

### Centralized vs. De-centralized Database

Parts of the database can be downloaded and stored in the device/UE 101 so that the correlation/fingerprinting takes place there instead of in the mobile edge function 113, potentially to operate at an even higher correlation rate or to decrease the use of communication resources (and freeing up even more opportunities for radar operations). In advantageous embodiments, the results (raw data measurements not the actual self-position) are shared with the mobile edge function database so that that data can be available to serve other UE's.

Therefore, some embodiments consistent with the invention are not dependent on the mobile edge function 113 containing all of the functions described above. To the contrary, aspects described above are applicable even in a distributed solution in which parts of the processing and data are managed by individual devices, enabling them to benefit from sharing data, map information, changes in the environments, and statistics through a function such as the mobile edge function 113. Furthermore, the knowledge of all positions of the devices enables many advantages, which in the various described embodiments is described as residing in the mobile edge function 113.

A person of ordinary skill in the art will readily understand that the mobile edge function 113 can be partly distributed in terms of actual processing and data access, but the devices need to share and collaborate in a way which is naturally managed by the mobile edge function 113 in the description set forth above. Therefore, the functions of the mobile edge function 113 and of the devices constitutes advantageous embodiments, but other embodiments are also contemplated being within the scope of the invention.

### Certain Key Structures or Radar-Posts

In some embodiments, certain structures or objects having distinct radar reflection signatures and considered stable in their position can be identified and specifically taken into consideration. In the general case, this can be any object or structure with a distinct radar reflection characteristic, but in the specific case this can be specific reflections designed for this purpose.

In one class of embodiments, the environment where the device is located may include a few dedicated reference points (e.g., radio reflectors, passive anchor points or iconic objects with distinguished RF characteristics). The objects can be wideband reflectors, or resonant structures with different properties at a particular resonance frequency. They could be polarized to reflect only one polarization. Still further embodiments comprise combinations of the above. There can also be different properties in different directions. Some structures could change shape with environment conditions and also enable remote sensing with radar.

In one aspect, these reference points can be arranged in the environment with a special location pattern. This can help the map correlation or fingerprinting algorithm increase its convergence rate. Furthermore, in case of ambiguity, the mobile edge function 113 can guide the device to beam its radar towards known such objects in order to determine or confirm position or direction.

### Exploiting Nearby Devices

Since the mobile edge function 113 maintains an updated view of where all radar-equipped devices are, the system can exploit this by, based on their latest known positioning requests and estimated trajectories, letting devices transmit/receive directly between each other to obtain further knowledge about their relative positions as well as for bistatic radar operation in order to get a better view regarding the objects between them. The details of this is beyond the scope of this description.

### How to Obtain Alternative Coarse-Grained World (Absolute) Reference

It is expected that a coarse-grained world reference position (WRP) can be obtained by a number of alternative means with varying costs in terms of power need, quality of the position and need for connectivity. An onboard GPS receiver can be used if available or be combined with network positioning for even higher quality of position, faster acquisition (so called assisted GPS), and the like.

In another aspect of some but not necessarily all embodiments, aspects described above can be used to provide a coarse-grained starting point by guessing where the device might reside given a map of the environment. Such a solution is entirely self-contained and would not depend on having a GPS and line of sight towards a satellite.

Yet another embodiment takes advantage of previous data points and, based on age of data points (more recent measurements are generally preferred) and presumed shift of position over time, reuses historical data obtained by the same system which would provide the most energy efficient generation of the coarse-grained world reference.

It is noted that as the positioning system continues to operate and refine the actual position this also functions to provide the device 101 with a new and accurate reference point effectively sub-planting the coarse-grained reference with a continuous high quality position only limited by the quality of the map data, the ranging resolution of the onboard radar, and the like.

### Alternative Device Sensor Such as IMU, Accelerometer or Compass

The various embodiments consistent with the invention do not depend on the use of an IMU, compass, or gyro, even though the function would benefit from that additional sensor to primarily determine direction. Knowing device orientation simplifies the correlation of radar signals relative to a map and simplifies guided radar operation since different directions can be pointed out by the mobile edge function 113. However, by analyzing the correlation from the different beams over multiple positions, it is possible for the mobile edge function 113 in collaboration with the device to determine its orientation without this additional sensor.

However, this requires a greater effort.

It is noted that an IMU in the most general sense can be anything that is able to measure the orientation and intrinsic motion of a device. Typically, this is done without the need for external information such as using a microelectromechanical system (MEMS) sensor setup with a gyro, an accelerometer and a magnetometer giving a device nine degrees of freedom (9DoF). This is not necessary for the function of the inventive embodiments, but can be used to provide additional datapoints to validate measurements and also fine tune the resulting position when combined with the radar based self-positioning. It is noted that typical IMUs are prone to drift over time (when used as a dead reckoning function) and typically need to be re-aligned with more stationary data points. The radar based self-position provided by inventive embodiments as described herein provides just that function.

In the absence of other means (e.g., intrinsic, such as IMU) or extrinsic methods (with an external entity providing the tracking of device inertial motion and change of orientation, aka Virtual IMU) the various embodiments will still work accurately as the map correlator function not only provides a reliable baseline (once it is locked to the correct and identified radar features) but also measures an accurate offset (or distance from) the identified (or fingerprinted) features. Adding information from beam directivity in communication towards the base station from a device know used panel will provide a relative orientation of this panel towards the base station 109 which has a known position in the room. This information might already be available as part of the initial network based positioning giving the WRP. From this, other sensors could detect a change. Or, if the device regularly performs communication towards the base station, it will also get this updated during self-positioning tracking.

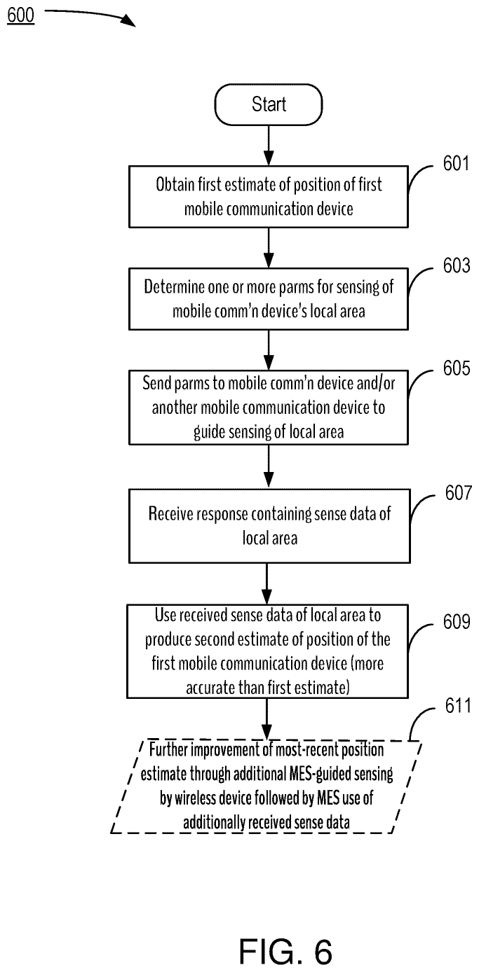

Additional aspects of inventive embodiments will now be described with reference to FIG. 6, which is, in one respect, a flowchart of actions performed by an exemplary server (e.g., a network component configured to have edge mobility functionality) configured to determine a location of a first mobile communication device in accordance with a number of embodiments. In other respects, the blocks depicted in FIG. 6 can also be considered to represent means 600 (e.g., hardwired or programmable circuitry or other processing means) for carrying out the described actions.

As shown beginning in FIG. 6, the process includes the server obtaining a first estimate of position of the first mobile communication device, wherein the first estimate of position indicates with a first degree of accuracy that the first mobile communication device is positioned within a local area portion of a reference coordinate system (step 601). The server then determines one or more parameters for a sensing of the local area (step 603), and sends, to one or more of the first mobile communication device and another mobile communication device, a request for the sensing of the local area in accordance with the one or more parameters (step 605). In response to the request for the sensing of the local area, the server receives sense data of the local area (step 607). The server uses the sense data of the local area to produce a second estimate of the position of the first mobile communication device, wherein the second estimate of position indicates with a second degree of accuracy that the first mobile communication device is positioned within the local area portion of the reference coordinate system, wherein the second degree of accuracy is more accurate than the first degree of accuracy (step 609).

In some but not necessarily all embodiments consistent with the invention, the accuracy of the position estimate is further improved by the server determining even further parameters for guiding even further sensing of the local area by the mobile communication device, and using this further sense data to further improve the estimated position of the first mobile communication device. The number of times that guided sensing followed by further refinement of the estimated position can be performed is implementation dependent, and can for example be a fixed number of times, or can alternatively be based on reducing an error level down to an acceptable level (where a threshold for acceptability is implementation dependent). All such embodiments are represented in FIG. 6 by action 611.

In view of the range of embodiments represented by FIG. 6, it will be understood that the term “first estimate of position” may be understood to generally represent a most recently obtained and/or determined estimate of the position of the mobile communication device, and that the term “second estimate of position” may be understood to generally represent a subsequently determined position estimate having a greater accuracy than that of the first estimate.

The discussion will now cover exemplary embodiments with a focus on aspects located in the mobile device itself.

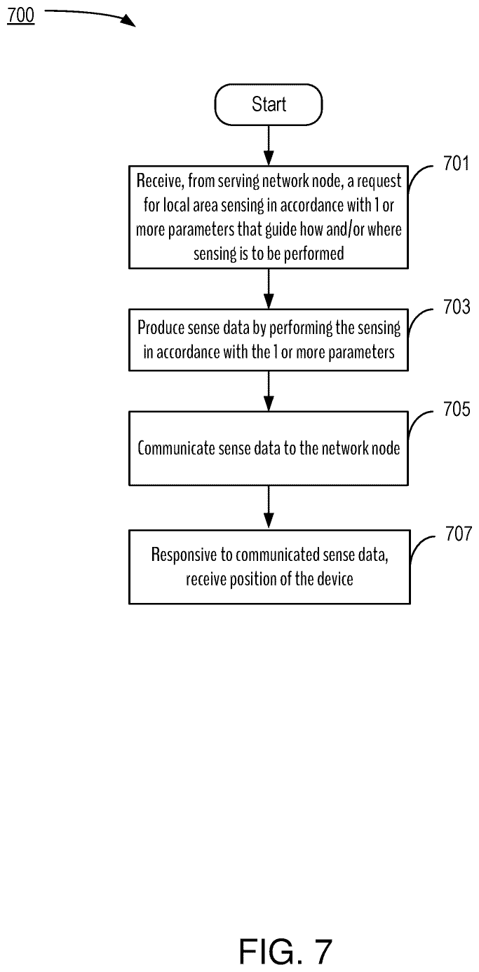

FIG. 7 is, in one respect, a flowchart of actions performed by an exemplary mobile communication device configured to perform sensing in accordance with a number of embodiments to produce data that can be analyzed to estimate the position of the mobile communication device. In other respects, the blocks depicted in FIG. 7 can also be considered to represent means 700 (e.g., hardwired or programmable circuitry or other processing means) for carrying out the described actions.

As shown in FIG. 7, the process includes the mobile communication device receiving, from a network node that serves the mobile communication device, a request for sensing of a local area in accordance with one or more parameters that guide how and/or where the sensing is to be performed (step 701). The type of sensing performed is different in a number of alternative embodiments. For example, some embodiments employ radar sensing as discussed above. But in alternative embodiments other types of sensing can be used such as optical sensing (including but not limited to camera sensors and LIDAR), inertial sensing by means of an inertial measurement unit (IMU), acoustic sensing (e.g., ultrasonic), sensing via a combination of different antenna panels of a (e.g., mobile) device, and sensing by means of Synthetic Aperture Radar (SAR). Embodiments employing SAR are described in greater detail later in this description.

In response to the request for the sensing of the local area, the mobile communication device produces sense data by performing the sensing in accordance with the one or more parameters (step 703). As discussed earlier, this may involve the mobile communication device performing the sensing in a particular direction and/or moving to a particular location from which the sensing is performed.

After producing the sense data (either raw sense data or, in alternative embodiments, sense data that is the result of processing raw sensing data by the mobile communication device), the mobile communication device communicates it to the network node (step 705).

In response to communicating the sense data to the network node, the mobile communication device receives its position (step 707). The position can, for example, be produced by a network node as described above.

As mentioned earlier, the mobile communication device can employ a number of different types of sensing. SAR sensing is one type that can advantageously be used in inventive embodiments. SAR sensing involves the performance of radar measurements from multiple radar antenna positions relative to a target. Known processing techniques are employed to combine the recorded radar sampling data to form a SAR radar image with higher spatial resolution than is possible with a single-shot radar. When SAR is used in embodiments consistent with the invention, a particular benefit is achieved by using mm Wave radar signals because the short wavelength and wide available bandwidth leads to high resolution which, when coupled with mm Wave signals' ability to penetrate materials better than higher frequency signals, leads to the production of high resolution images having an increased signal to noise ratio. This enables the detection of features that are ordinarily hidden to other sensing techniques (e.g., “see through” cloth or “see in” walls).

Techniques for embodying mmWave radar in a mobile communication device are known in the art, such as embodiments shown in International Patent Application “Radar Implementation In a Communication Device”, PCT/EP2020/069491. For example, it has been shown that it is possible to extend UE modem capability to include mm Wave SAR functions. The added cost of the radar functionality on top of that of an ordinary 5G modem is minimal. This means that the modem can be used for the essential functions of the positioning system which include, for example:
Communicating with the base station and the functions in the mobile edge server
Radar sensing at mm Wave frequencies, different beam directions, and with different signaling types and durations

Although a 5G modem has been mentioned, this is merely for purposes of example and is not an essential aspect of inventive embodiments. Those of ordinary skill in the art will appreciate that other communication standards or generations of the 3GPP standard can alternatively be used in embodiments consistent with the invention.

Using the device's modem for radar functionality is not an essential aspect of inventive embodiments. In alternative embodiments, the radar functionality might be provided by a separate module that communicates through the 5G modem to access the network-based aspects in accordance with embodiments consistent with the invention. Having a separate radar module adds cost and complexity, however.

In another aspect, a mobile device in some but not necessarily all embodiments is equipped with an IMU or accelerometer, gyro, compass or other sensor(s) to extract/estimate SAR scanning trajectory. These sensors can also be used to understand device orientation and relative movements to further support the positioning scheme (e.g., as may be required to perform the network guided scanning as discussed above).

In overview, then, radar sensing capabilities in a mobile device can be achieved with a minimal hardware change to its radio communication circuit. For example, in a 5G cellular phone, mm Wave radar functionality can be implemented by using the RF beamforming transceiver. By performing mm Wave radar measurements from varying positions relative to a concealed object (e.g., inside a wall) SAR processing techniques can combine the recorded data from the multiple radar antenna positions to form a SAR radar image of the concealed object with high resolution. Other sensors, for example an IMU, can be used to estimate/extract radar sampling positions and compensate the variable movement of SAR scanning trajectory. The SAR radar technology can be leveraged to assist the mobile device locate itself in a map or relative to recorded radar data through fingerprinting methods.

A mobile device equipped with a mm Wave radar moves around in a scene and performs SAR scanning on its surrounding objects (e.g., walls, floors and ceilings). By looking through a wall (and/or floor, ceiling, etc.) with high resolution, the device can detect the detailed structures within the wall. The detected structures can then be used as a fingerprint that is correlated with map information in which the features of the wall are stored. From the correlation results, the position of the device in the map can be estimated.

The achievable accuracy with a SAR-assisted method is much better than what traditional radar-based positioning solutions can achieve. Applications include autonomous carts driving around on a factory floor, or drones in an indoor environment, but there are a large number of other potential applications for this technique.

As mentioned above, a mobile device performing self-positioning may find itself in certain areas in which the conventional radar sensing from the device cannot capture sufficient recognizable objects to locate itself. Such an area could for example be a long corridor with flat walls or areas where static recognizable objects might be blocked by moving people/objects which dynamically change the radar environment. If the device is equipped with an IMU, this can assist to some extent to make a prediction (e.g., within a corridor) but accumulated IMU errors could increase and thereby reduce overall accuracy.

To invoke SAR-assisted self-location, a decision should be made whether the device has entered such an area, and this can be based on one or a combination of:
A currently known estimate of position and the moving vector of the device
Edge cloud knowledge from previous self-positioning operation of the device or other devices
Knowledge of building structures which may be included in a map stored in the edge cloud
Knowledge about areas densely populated with moving objects (like people at the entrance of a shopping mall at peak hour) blocking radar view towards recognizable objects

The radar self-positioning performance of a device in such areas could be improved by adding radar reflectors/anchors with some detectable characteristics. However, due to various reasons (e.g., esthetic reasons) it might not be a desirable and/or feasible alternative.

With the herein-described mm Wave SAR technique, it is possible for a device to detect structures with high resolution inside a building material. Consider, for example, a wall. A wall generally consists of invisible equidistant load bearing material of either solid wood or metal covered by external plasterboard. Other objects that may be located inside a wall include cables or other electrical items or water pipes. These features can be detected by SAR and exploited by the device to locate itself.

An exemplary system utilizing mm Wave SAR technology for self-positioning comprises:
Mobile devices (e.g., smartphones, tablets, XR/VR headset) with either a mm Wave Radar module or a modem (or UE, User Equipment), that is extended with mmWave Radar functionality. The devices can also be equipped with IMU sensors to estimate/extract radar sampling positions.
A cellular communication system in which the UE's are communicating with a base station.
An edge cloud server. This can be a separately located network entity, or can alternatively be a server residing at the base station for providing services that are local to that area and with lower latencies than going over-the-top to a datacenter beyond the perimeter of the telecom operator.
With a mobile device performing mm Wave radar measurements from varying positions relative to a concealed object (e.g., inside a wall, above a ceiling), SAR processing techniques are employed by the mobile device in some embodiments to combine the recorded data from the multiple radar antenna positions to form a SAR radar image of the concealed object with high resolution. Other sensors (e.g., IMU) can be used to estimate/extract radar sampling positions and compensate for the variable movement of SAR scanning trajectory.

In alternative embodiments, the communication modem in the mobile device is used to transfer the radar data to a network, which then processes the radar data to reconstruct SAR images and correlate the SAR images to a data set which can be extracted from the building structure or from previous measurements by the device itself or other devices. The processing (which can be computationally costly) of the radar data and correlation with a set of known map features may further be done using a cloud server, a mobile edge function or even on the device itself (albeit at a cost of use of additional power that may drain the battery). Processing on the device itself assumes that a world reference position (WRP) and map data have been downloaded into the device.

In one use case, when moving along one or more corridors/walls, a mobile device equipped with a mm Wave radar performs SAR scanning on the wall(s). By looking through the wall with high resolution, the device can detect the detailed structures within the wall (as shown in SAR radar images). The detected structure(s) (or features extracted from the SAR radar images) can then be used as a fingerprint and correlated to a map where the known feature of the wall is stored. From the correlation result, the device can estimate its self-position in the map. The method can be further extended to floor (or ceiling) SAR scanning.

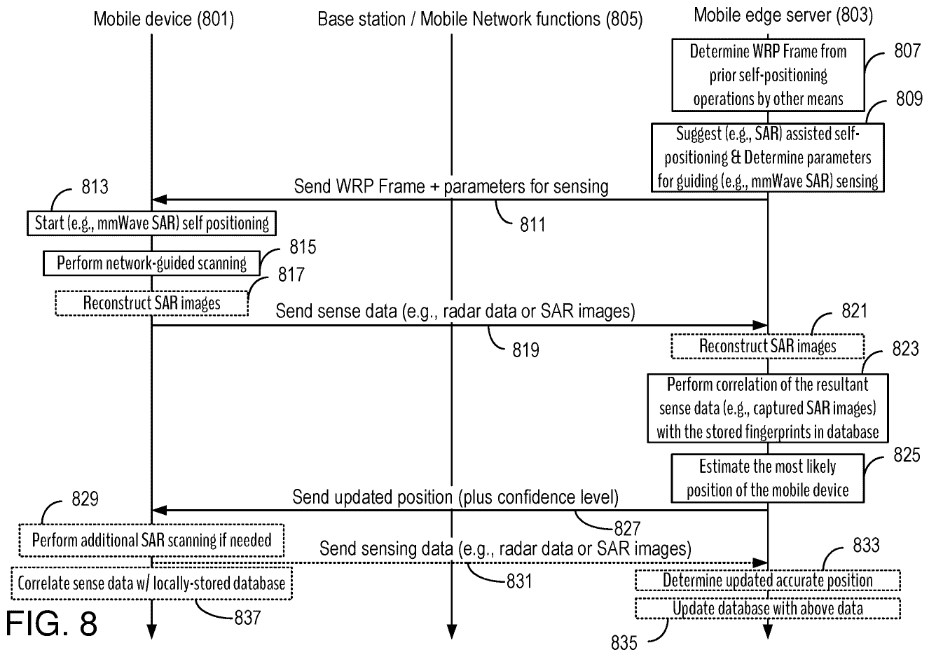

To illustrate some further aspects of some but not necessarily all alternative embodiments consistent with the invention, the description will now make reference to the exemplary signaling diagram illustrated in FIG. 8. Features depicted with dotted lines and boxes represent aspects that are optional to this exemplary embodiment. In this example, a mobile device 801 mobile edge server 803 are able to communicate directly with one another. Although the mobile device is served by, for example, a base station 805, the base station does not take part in mm Wave SAR-assisted self-positioning actions. However, in some alternative embodiments mobile device 801 may need to communicate with the mobile edge server 803 via the base station 805 as an intermediary. Those of ordinary skill in the art will readily understand how to adapt the teachings presented herein for use in such embodiments.
7. The mobile edge function 803 determines a WRP-Frame that corresponds to a current estimate of the mobile device's position (WRP) (step 807) that was determined by other means (e.g., by using any of the methods described above). The WRP can be determined by the mobile device 801 (see, e.g., FIG. 3A and accompanying text) or by the base station 805 (see, e.g., FIG. 5 and accompanying text).
8. The mobile edge function 803 decides (e.g., based on any one or more of the factors outlined above) that network-assisted self-positioning would improve the current estimate of position, and accordingly determines parameters for guiding the radar operation based on the area, relevant objects in the surrounding, its allowed use of radar in certain frequency bands, and the like (step 809). In some but not necessarily all embodiments, the guidance can also be based on whether and what kind of radar capability the device 801 has (e.g., whether it has mmWave SAR capability). Device capability information can be supplied to the mobile edge function 803 in any number of ways including but not limited to receiving it from the device 801. By performing the sensing in accordance with the mobile edge function's guidance, the device 801 can perform its radar operation in an optimized way that takes into account the mobile edge function's holistic knowledge of the map in that area, other mobile devices and known dynamics in the environment, and previous historical measures from other devices in that area. The mobile edge function 803 then sends the WRP-Frame and sensing guidance parameters to the mobile device 801 (step 811).
9. The device 801 then begins its self-positioning procedure (step 813) and performs the sensing in accordance with received parameters (step 815). For example, if conventional radar sensing or mm Wave SAR sensing has been requested, the device 801 emits radar sequences and receives the response. The settings for the radar are based on the device knowledge of features indicated on the map and on the received guidance from the mobile edge server 803.
10. The device 801 sends resultant sense data to the mobile edge server 803 (step 819). For example, the resultant data may be raw radar data. Alternatively, if mm Wave SAR sensing has been performed, the raw data needs to be processed to reconstruct SAR images.
11. (optional) In some embodiments in which mmWave SAR sensing has been performed, the mobile device 801 reconstructs the SAR images (step 817), and these are the resultant data.
12. (optional) In some embodiments in which mm Wave SAR sensing has been performed, the mobile device instead uses the raw radar data as the resultant data, and the mobile edge server 803 reconstructs the SAR images from the received raw radar data (step 821).
13. The mobile edge server 803 correlates the received sense data with reference sets of previously obtained reflections from known positions that are stored in its database (step 823).
14. Based on the correlation results, the mobile edge server 803 determines a sufficiently accurate estimate of the mobile device's position (step 825) and sends this to the mobile device 801 (step 827). (What constitutes “sufficient” accuracy is implementation dependent, and is therefore beyond the scope of this disclosure.) The mobile edge server 803 may, in some embodiments, also communicate a confidence level with regard to position accuracy. In some but not necessarily all embodiments, the mobile edge server 803 also provides additional guidance for performing further sensor measurements in case the confidence level does not satisfy a predetermined confidence threshold.
15. (optional) The mobile device 801 may (e.g., based on confidence level) perform additional sensing (e.g., additional mmWave SAR scanning) if needed (e.g., if the communicated confidence level does not satisfy a predetermined threshold level (step 829).
16. (optional) If additional sensing was performed, the mobile device 801 communicates the additional sense data to the mobile edge server (step 831).
17. (optional) If additional sense data was received, the mobile edge server 803 uses it to determine an updated accurate position of the mobile device 801 (step 833). Depending on why the additional sense data was obtained, the updated accurate position in this step can also be sent to the mobile device (not shown).
18. (optional) In any of the above indicated options, the mobile edge server 803, having determined an accurate estimate of the mobile device's position based on new sensing data, may update its database with the relevant data from the device 801 as well as the determined accurate position (step 835). The updated database will accordingly enable the production of more accurate positioning estimates for this mobile device 801 as well as others in subsequent positioning requests.

Another aspect of some embodiments in which mm Wave SAR sensing is performed for self-location concerns the SAR database of known reflections against which sensed data is correlated. There are a number of options for creating a SAR fingerprint database. One of these is to pre-characterize the surface to be sensed (e.g., wall, floor, ceiling, etc.) during an initial system calibration procedure. This process includes performing SAR scanning on selected parts of the surface, extracting their detectable features (i.e., fingerprints) and storing the fingerprints and the corresponding positions into a map.

Another option is to deliberately embed SAR anchor nodes with known SAR characteristics within known position inside a surface (e.g., wall, floor, ceiling, etc.). Convenient times for doing this include times of renovation or initial construction of buildings, but of course the timing is not an essential aspect of inventive embodiments. Because of the surface-penetrating properties of mm Waves, these inbuilt anchor points with specific shapes (e.g., physical structures) or RF reflectivity (e.g., a pattern painted using RF sensitive paint) can be made hidden to human perception for esthetic reasons while remaining visible/detectable to mm Wave radar sensing. Specific shapes and/or distribution patterns of these anchor points can be selected for a given surface (e.g., wall), which can be used as a fingerprint of the surface.

Such structures would be fully passive. The shapes and/or distribution patterns can be configured based on the fact that radar structures are recognized as surfaces with incidental normal planes relative to the antenna bore sight. The arrangement of the edges of these surfaces adds significantly to the characteristics of the reflected signals. Example of such structures include small-sized radar reflectors suitable for millimeter waves and/or patterns of millimeter wave radar reflective paint. Then the SAR fingerprints and their corresponding positions are stored into a map.

The various options can be combined in the sense that the first option (i.e., pre-characterizing sensing of an area) might be used to fine tune the positions of the second option's inbuilt anchor points.

In all of these alternatives, the map with SAR fingerprints can be stored into a database that is maintained by a mobile edge server, which uses it as a reference map against which sensed data is correlated.

Alternatively, a SAR-enabled device having an accurate estimate of position can be instructed to scan objects and provide data to a central database for future usage. This can be useful for detecting new objects identified from regular (i.e., non-SAR) radar transmission and hence not present earlier or it can be within areas not covered by above methods.

The mobile edge server 803 for embodiments involving mm Wave SAR sensing shares aspects described above in connection with other embodiments. It contains the map of the environments as well as the database of SAR fingerprints (with their corresponding locations). It can also run the algorithms of correlation between the stored fingerprint and the measured SAR image features to estimate which is the most likely position of the device 801 within a limited geographical area. The estimation result can then be sent back to the device 801. Moreover, the positioning functionality can serve all devices in the coverage of the base station 805. The mobile edge server 803 can further aggregate the data from multiple devices, which can be used to update the map and/or the fingerprint database.

And as mentioned earlier, the mobile edge server 803 gives initial guidance to directions towards suitable SAR objects in close proximity to the device 801 (e.g., based on an initial position estimate) as candidates for positioning correlation.

Further, in alternative embodiments the functionality of the mobile edge server 803 can be embodied as extensions to the functionalities in the base station 805 instead of being a separate (or at least separately located) entity. Thus, it is not essential for inventive embodiments that this function reside in the mobile edge server 803. However, there is a natural advantage to collocating mobile edge server functionality with that of the base station 805, given its close connection to the base station 805, the fact that it then naturally covers a certain limited geographical area, has shorter latencies than a remote over-the-top datacenter, and it has larger storage and more computational performance than the UE's or mobile devices 801.

Another aspect of some but not necessarily all embodiments involves when to enable SAR mode sensing and when to disable it (e.g., to perform an alternative type of sensing).

Because SAR image reconstruction demands more computational resources than regular radar operation, the SAR operation adds processing complexity and might require further data transfer. The SAR operation can be enabled whenever particular embodiments/applications find it necessary, so that the SAR mode of radar operation of the device can be a complement to its regular radar operation. Of course, “when necessary” is implementation dependent, making a full discussion beyond the scope of this disclosure.

In one exemplary embodiment, a device autonomously enables its mm Wave SAR radar mode when entering an area lacking a sufficient number of objects capable of providing unique signatures for ordinary radar and the error of its regular radar-assisted self-position (or IMU position) algorithm is above a threshold.

In an alternative exemplary embodiment, a device's mm Wave SAR sensing mode is enabled by a cloud or edge cloud which tracks the device. The cloud can guide the SAR operation based on the device's initial position (and potentially IMU's if supported) and a priori knowledge of positions of SAR reference objects in areas where the regular radar-assisted self-positioning has low accuracy (or cannot meet application requirements with required positioning accuracy at a certain confidence level) or in areas where there are significant recognizable structures that SAR would be able to take advantage of.

In another alternative exemplary embodiment, when multiple devices are available in a scene, mm Wave SAR self-positioning functionality may be enabled in one (or some) of these devices, while the rest of the devices perform only non-SAR radar self-positioning functions. By positioning itself with higher precision and sharing its position with other devices, a SAR enabled device can be used as a reference point by a normal radar device so that the positioning precision of the normal radar device can be improved. Moreover, which ones and how many of the devices are to be enabled with mmWave SAR self-positioning can be adapted to the positioning precision requirement.

In another aspect of some but not necessarily all embodiments consistent with the invention, parts of the database can be downloaded and stored in a device so that the correlation/fingerprinting takes place there instead of in the Edge Cloud. (See, for example, step 837 in FIG. 8). In preferred embodiments, the results are still communicated to the edge cloud database so that the database can be updated accordingly and subsequently serve other devices when they perform self-positioning. A relevant use case for this embodiment involves a device with limited mobility, so that it only moves within a small area where there are little or no dynamics in its environment. In such instances, it might be more beneficial to have relevant parts of the database locally stored within the device (as long as processing and power allows). By contrast, a highly mobile device with limited processing capability operating in environments with large dynamics might prefer the edge cloud approach.

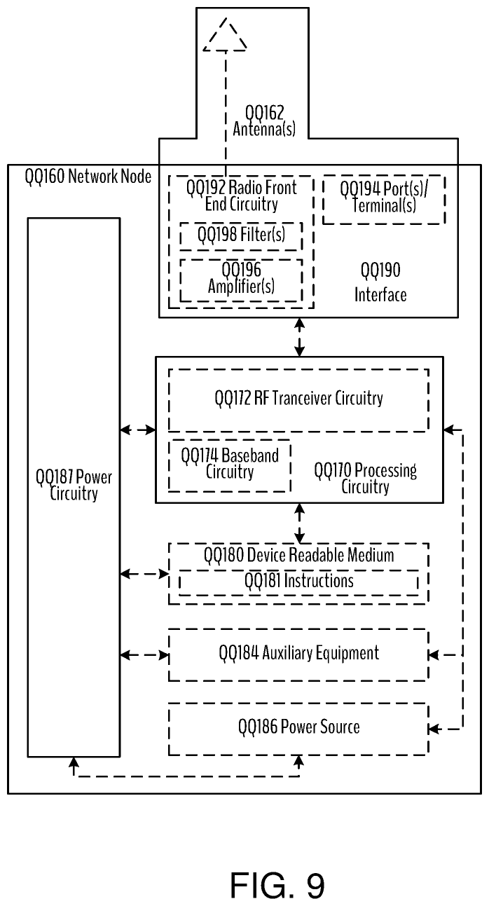

To further illustrate aspects of some but not necessarily all embodiments consistent with the invention, FIG. 9 shows details of a network node QQ160 according to one or more embodiments. In FIG. 9, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a radio network controller (RNC) component, or a base transceiver station (BTS) component and a base station controller (BSC) component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions QQ181 stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units. In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signaling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or wireless devices via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 9 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

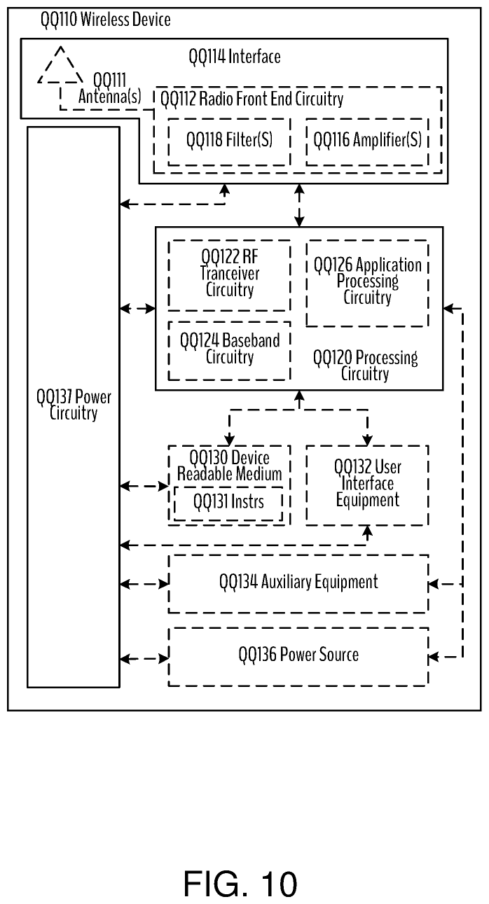

To further illustrate aspects of some but not necessarily all embodiments consistent with the invention, FIG. 10 shows details of a wireless device QQ110 according to one or more embodiments. As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a machine-type communication (MTC) device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

FIG. 10 shows details of a wireless device QQ110 according to one or more embodiments. As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions QQ131 stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a System On a Chip (SOC). In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes (e.g., radar functionality as described herein), interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

It will be appreciated that an important aspect of various embodiments relates to the collaboration between the mobile device with the radar function and the mobile edge function (MEF) having holistic data, having more resources to perform correlations to determine accurate position, and serving multiple mobile devices while iteratively improving and updating its data. In this regard, the following aspects are among those that are notable:
Split device—mobile edge function (MEF) positioning, so that the device performs radar and the MEF performs correlation according to the above-described embodiments. This opens up a number of optimizations such as: the MEF has access to all dynamic changes from all devices, the MEF can guide device based on map and characteristics of surroundings (no need to pre-load a lot of data into device), the MEF can perform more advanced fine-tuning by combining techniques, and the MEF can learn from the combined fine-tuning techniques.
Iterative finetuning after movement in order to resolve situations where the fine-tuning comes up with ambiguity/too low confidence in the exact position (because of noise, artifacts, or dynamically changed environment): based on the most likely positions in the coarse position area (potentially multiple), the movement between two radar analyses is estimated and the new fine-tuning is based on assessment of new radar-based finetuning in combination with previous candidate plus delta-movement.

The MEF can identify that certain points/structures are very reliable as “anchor points” relative to other reflections. Areas with lack of recognizable unique structures can be identified and serve as input to improvements like adding structures or anchor points.
The base station can perform the above-mentioned MEF. Furthermore, the base station can benefit from the knowledge of the above function.
Since the MEF has information about the radar-UE in relation to the surroundings, it can guide the radar-usage in the UE (which directions, which relative power levels, etc.) for better efficiency and best usage of its resources and minimal interference. It is also capable of benefiting from previous measurements as well as from relative position to the structures in the map.
Since the MEF has information about all radar-equipped devices in area, it can filter out dynamic changes of the environment coming from the objects of other close-by UEs—for example, the position and movement of autonomous carts having a radar-equipped UE will be known and its impact on other UE's radar analysis can be compensated for accordingly.

Various aspects of inventive embodiments as set forth above can be applied to provide a mechanism and technology for UE's, and/or mobile devices, to get their positions at an accuracy much better than what traditional network-based positioning solutions offer.

This can be especially useful when applied in, for example, autonomous carts driving around on a factory floor, or drones in an indoor environment. However, this is by no means a complete list of application; to the contrary, there are a large number of potential applications for this technology.

Embodiments consistent with the invention provide a number of advantages over conventional technology relating to the fact that very detailed self-positioning is enabled without the need for classical sensor-fusion approaches. This is achieved by making several clever usages of the modem and the cellular system. For example, and without limitation:
In some embodiments, the modem is used in order to get a first (less accurate) position from the cellular system, as a world reference.
In some embodiments, the radar function can be built into the 5G modem with almost no additional cost
In some embodiments, the modem is used to communicate with the mobile edge server which performs the correlation functions as well as enables a large set of clever optimizations

It is further noted that the embodiments are not dependent on the radar being operated in 3GPP spectrum, and are not dependent on the radar being implemented as integrated in the modem hardware, but this does constitute an advantageous embodiment.

The above-described embodiments provide a very accurate positioning solution for all devices with a 5G modem (radar enabled), without the need for a dense installment of base stations or radio sources other than what is needed for communication, and without the need for cameras or other complex sensor-fusion solutions. This is a solution that easily scales across a factory for example.

Further advantages include:
Low cost relative to alternative sensor-fusion solutions for high-accuracy positioning, e.g. adding a camera module
Significantly higher accuracy than traditional radio-based solutions conventionally found in, for example, cellular or Bluetooth-compliant systems
The addition of radar functionality in a modem can add value also to other types of applications, such as a map with feature references as seen from all (radar equipped) modems and their surroundings in the base station or the edge cloud function which can enable a number of applications and advantages
An optimized approach for determining a WR-Frame within which the correlation takes place. Conventional approaches need to apply a pessimistic approach which often leads to larger WR-Frame.
The joint operation between edge cloud map services and UE-based radar sensing allows for several optimizations such as adapting the signaling and frequencies of the radar sensing to fit the topology and objects of the estimated area in the map, and to benefit from the knowledge of other mobile units in close proximity to the UE
The embodiments consistent with the invention improve over time (as devices collect more samples that may improve overall accuracy) and may then also identify and adapt to changes in the environment
Devices may contribute insights about the mapped out area that could only be seen by a device in that location (e.g., not reached by radio signals from the base station alone).

Moreover, embodiments in which a mobile device utilizes mm Wave SAR sensing as part of a self-positioning methodology provide a number of advantages of conventional approaches, including:
Low cost relative to alternative sensor-fusion solutions for high-accuracy positioning, e.g. adding a separate radar module or a camera module, or with that of a positioning solution with many anchor-points or base stations to guarantee line-of-sight with multiple base stations at the same time from all positions.
Ability to achieve significantly higher accuracy than traditional radar-based solutions
Improvement beyond previous work by opportunities to exploit detailed structures beyond walls, floors or ceilings, as well as other structures that are not as clearly distinguished with regular radar.

The invention has been described with reference to particular embodiments. However, it will be readily apparent to those skilled in the art that it is possible to embody the invention in specific forms other than those of the embodiment described above.

For example, the various embodiments have made reference to a mobile edge server. However, the use of a mobile edge server is not an essential aspect of inventive embodiments. To the contrary, any server performing the herein-described functionality may be used (e.g., a cloud server as well as a server located in mobile network such as but not limited to an edge of the mobile network), and the term “server” is accordingly used herein to denote any such embodiment.

In another example, the embodiments have referred to only one WRP. However, in some embodiments it is possible that multiple WRPs are available, each with its own confidence interval (i.e., with respect to accuracy). In such instances, multiple WR-Frames can be determined and these can be used in a number of different ways, such as:
a. The intersection between the multiple WR-Frames can be determined, and the processing considering only a space that is compliant with them all.
b. The union between the multiple WR-Frames can be determined, and the processing can then be configured consider the combined space(s). This class of embodiments can be relevant in case the multiple WR-Frames define areas that are disjunct, and there is no available prior knowledge about where the device is.
c. One or more of the multiple WR-Frames can be disregarded entirely when, for example, the system already has some understanding about where the device is, or if there is statistical data indicating how certain WR methods perform in that specific area.

Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. A method of determining a location of a first mobile communication device, comprising a server performing:
obtaining a first estimate of a position of the first mobile communication device wherein the first estimate identifies a position within a local area portion of a reference coordinate system;
determining one or more parameters that guide a sensing of a local area of the first mobile communication device;
sending the one or more parameters to the first mobile communication device;
in response to the sending, receiving first sense data of the local area; and
using the first sense data of the local area to determine a second estimate of the position of the first mobile communication device wherein the second estimate is more accurate than the first estimate.

2. The method of claim 1, comprising:
obtaining a measure of accuracy of the first estimate of the position of the first mobile communication device; and
determining whether the measure of accuracy of the first estimate of the position (207) of the first mobile communication device satisfies a predefined threshold level of accuracy,
wherein sending the one or more parameters is performed when the measure of accuracy of the first estimate of the position of the first mobile communication device does not satisfy the predefined threshold level of accuracy.

3. The method of claim 2, wherein the measure of accuracy of the first estimate of the position of the first mobile communication device is obtained from the first mobile communication device

4. The method of claim 1, comprising:
detecting that the first mobile communication device is located in a local area for which historical sense data that is available to the server does not satisfy at least one predetermined criterion,
wherein sending the one or more parameters is performed in response to said detecting.

5. The method of claim 1, wherein:
the sensing of the local area is radar sensing of the local area; and
the one or more parameters define a pose that the first mobile communications device is to assume when performing the radar sensing of the local area.

6. The method of claim 1, wherein:
the sensing of the local area is radar sensing of the local area; and
the one or more parameters define movement to a location at which the radar sensing of the local area is to be performed.

7. The method of claim 1, wherein the sensing of the local area is millimeter-wave Synthetic Aperture Radar (mmWave SAR) sensing.

8. The method of claim 7, wherein the one or more parameters define a direction and/or an orientation to be applied when performing the mmWave SAR sensing.

9. The method of claim 7, wherein using the first sense data of the local area to determine the second estimate of the position of the first mobile communication device comprises correlating the first sense data of the local area with a reference map that includes information about one or more physical features located behind one or more materials from a viewpoint of the first mobile communication device

10. The method of claim 1, wherein the sensing of the first area is non-radar based sensing.

11. The method of claim 1, wherein:
the sensing of the local area is radar sensing of the local area; and
the one or more parameters define one or more of:
a higher power setting of radar signaling than was used in a previous sensing by the first mobile communication device;
a larger bandwidth setting of radar signaling than was used in a previous sensing by the first mobile communication device;
a longer signal duration of radar signaling than was used in a previous sensing by the first mobile communication device; and
an additional frequency to be used for radar signaling than was used in a previous sensing by the first mobile communication device.

12. The method of claim 1, comprising:
sending the second estimate of the position of the first mobile communication device to the first mobile communication device.

13. The method of claim 1, comprising:
using the first sense data of the local area as a basis for revising a reference map of the local area.

14. The method of claim 1, comprising;
initially using non-radar based information to obtain the first estimate of the position of the first mobile communication device

15. The method of claim 1, wherein the first estimate of the position of the first mobile communication device is obtained from the first mobile communication device

16. The method of any claims claim 1, comprising:
causing the second estimate of the position of the first mobile communication device to be used as a basis for adjusting a telecommunications function of a telecommunications network node of a telecommunications network, wherein the telecommunications function pertains to the first mobile communications device operating in the telecommunications network.

17. The method of claim 1, comprising:
sending to a second mobile communication device one or more second parameters that guide a sensing of the local area by the second mobile communication device and
receiving second sense data from the second mobile communication device
wherein using the first sense data of the local area to determine the second estimate of the position of the first mobile communication device comprises:
using the first sense data and the second sense data to determine the second estimate of the position of the first mobile communication device.

18. The method of claim 1, wherein using the first sense data of the local area to determine the second estimate of the position of the first mobile communication device is based on a correlation between the first sense data and a reference map and wherein using the first sense data of the local area to determine the second estimate of the position of the first mobile communication device comprises:
detecting a pattern of changes with respect to an object or feature represented in the reference map and using knowledge about the detected pattern when correlating the first sense data with the reference map.

19. The method of claim 1, wherein using the first sense data of the local area to determine the second estimate of the position of the first mobile communication device is based on correlation results produced by correlating the first sense data with a reference map and wherein the method comprises:
obtaining information about a position and/or movement of a second mobile device and
filtering the correlation results to account for the position and/or movement of the second mobile device.

20. A non-transitory computer readable storage medium comprising a computer program comprising instructions that, when executed by at least one processor causes the at least one processor to carry out a method of determining a location of a first mobile communication device, wherein the method comprises a server performing:
obtaining a first estimate of a position of the first mobile communication device, wherein the first estimate identifies a position within a local area portion of a reference coordinate system;
determining one or more parameters that guide a sensing of a local area of the first mobile communication device;
sending the one or more parameters to the first mobile communication device;
in response to the sending, receiving first sense data of the local area; and
using the first sense data of the local area to determine a second estimate of the position of the first mobile communication device, wherein the second estimate is more accurate than the first estimate.

21. (canceled)

22. A server for determining a location of a first mobile communication device comprising:
circuitry configured to obtain a first estimate of a position of the first mobile communication device, wherein the first estimate identifies a position within a local area portion of a reference coordinate system;
circuitry configured to determine one or more parameters that guide a sensing of a local area of the first mobile communication device
circuitry configured to send the one or more parameters to the first mobile communication device;
circuitry configured to receive first sense data of the local area in response to the sending; and
circuitry configured to use the first sense data of the local area to determine a second estimate of the position of the first mobile communication device, wherein the second estimate is more accurate than the first estimate.

23. The server of claim 22, comprising:
circuitry configured to obtain a measure of accuracy of the first estimate of the position of the first mobile communication device; and
circuitry configured to determine whether the measure of accuracy of the first estimate of the position of the first mobile communication device satisfies a predefined threshold level of accuracy,
wherein the circuitry configured to send the one or more parameters to the first mobile communication device is configured to send the one or more parameters when the measure of accuracy of the first estimate of the position of the first mobile communication device does not satisfy the predefined threshold level of accuracy.

24. The server of claim 23, wherein the measure of accuracy of the first estimate of the position of the first mobile communication device is obtained from the first mobile communication device.

25. The server of claim 22, comprising:
circuitry configured to detect that the first mobile communication device is located in a local area for which historical sense data that is available to the server does not satisfy at least one predetermined criterion,
wherein the circuitry configured to send the one or more parameters to the first mobile communication device is configured to send the one or more parameters in response to a detecting.

26. The server of claim 22, wherein:
the sensing of the local area is radar sensing of the local area; and
the one or more parameters define a pose that the first mobile communications device is to assume when performing the radar sensing of the local area.

27. The server claim 22, wherein:
the sensing of the local area is radar sensing of the local area; and
the one or more parameters define movement to a location at which the radar sensing of the local area is to be performed.

28. The server of claim 22, wherein the sensing of the local area is millimeter-wave Synthetic Aperture Radar (mmWave SAR) sensing.

29. The server of claim 28, wherein the one or more parameters define a direction and/or an orientation to be applied when performing the mm Wave SAR sensing.

30. The server of claim 28, wherein the circuitry configured to use the first sense data of the local area to determine the second estimate of the position of the first mobile communication device comprises circuitry configured to correlate the first sense data of the local area with a reference map that includes information about one or more physical features located behind one or more materials from a viewpoint of the first mobile communication device

31. The server of claim 22, wherein the sensing of the first area is non-radar based sensing.

32. The server of claim 22, wherein:
the sensing of the local area is radar sensing of the local area; and
the one or more parameters define one or more of:
a higher power setting of radar signaling than was used in a previous sensing by the first mobile communication device;
a larger bandwidth setting of radar signaling than was used in a previous sensing by the first mobile communication device;
a longer signal duration of radar signaling than was used in a previous sensing by the first mobile communication device; and
an additional frequency to be used for radar signaling than was used in a previous sensing by the first mobile communication device.

33. The server claim 22, comprising:
circuitry configured to send the second estimate of the position of the first mobile communication device to the first mobile communication device.

34. The server of claim 22, comprising:
circuitry configured to use the first sense data of the local area as a basis for revising a reference map of the local area.

35. The server of claim 22, comprising;
circuitry configured to initially use non-radar based information to obtain the first estimate of the position of the first mobile communication device.

36. The server of claim 22, comprising circuitry configured to obtain the first estimate of the position of the first mobile communication device from the first mobile communication device.

37. The server of claim 22, comprising:
circuitry configured to cause the second estimate of the position of the first mobile communication device to be used as a basis for adjusting a telecommunications function of a telecommunications network node of a telecommunications network wherein the telecommunications function pertains to the first mobile communications device operating in the telecommunications network.

38. The server of claim 22, comprising:
circuitry configured to send to a second mobile communication device one or more second parameters that guide a sensing of the local area by the second mobile communication device and
circuitry configured to receive second sense data from the second mobile communication device
wherein the circuitry configured to use the first sense data of the local area to determine the second estimate of the position of the first mobile communication device comprises:
circuitry configured to use the first sense data and the second sense data to determine the second estimate of the position of the first mobile communication device.

39. The server claim 22, wherein the circuitry configured to use the first sense data of the local area to determine the second estimate of the position of the first mobile communication device is configured to base determination of the second estimate on a correlation between the first sense data and a reference map and wherein the circuitry configured to use the first sense data of the local area to determine the second estimate of the position of the first mobile communication device comprises:
circuitry configured to detect a pattern of changes with respect to an object or feature represented in the reference map and using knowledge about the detected pattern when correlating the first sense data with the reference map.

40. The server claim 22, wherein the circuitry configured to use the first sense data of the local area to determine the second estimate of the position of the first mobile communication device is configured to base determination of the second estimate on correlation results produced by correlating the first sense data with a reference map, and wherein the server comprises:
circuitry configured to obtain information about a position and/or movement of a second mobile device and
circuitry configured to filter the correlation results to account for the position and/or movement of the second mobile device
